(19) United States
(12) Patent Application Publication
(10) Pub. No.: US 2018/0211342 A1
(43) Pub. Date: Jul. 26, 2018

(54) CONTROL OF CONTENT DISTRIBUTION

(71) Applicant: Crowdaa, Inc., San Francisco, CA (US)

(72) Inventor: Yann Vigile Hoareau, San Francisco, CA (US)

(21) Appl. No.: 15/878,904

(22) Filed: Jan. 24, 2018

Related U.S. Application Data
(60) Provisional application No. 62/450,010, filed on Jan. 24, 2017.

(51) Int. Cl. G06Q 50/18; H04L 29/06; G06Q 50/00; G06Q 30/02; G06Q 10/06

(52) U.S. Cl. CPC G06Q 50/184; H04L 65/60; H04L 67/02; G06Q 30/0277; G06Q 10/067; G06Q 50/01

(57) ABSTRACT

A content distribution service is disclosed that enables artists to define distribution models on a per-content basis. An artist uploading content items to the service for distribution is provided mechanisms to define a distribution model for each of content items. Using such a mechanism, the artist can control content prices, allowed usage within the distribution model, options for unlocking the content, etc. When another user attempts to access the content, the service determines if the content has been unlocked for the user and whether the requested access satisfies certain conditions of the distribution model set by the artists. If the content is not unlocked and the requested access does not satisfy the conditions of the distribution model, the requesting user is provided options to unlock the content, for example, through purchasing the content or performing other activities such as sharing posts through social media promoting the content.

### CROSS-REFERENCE TO RELATED APPLICATION(S)

This application claims priority to U.S. Provisional Patent Application No. 62/450,010 filed on Jan. 24, 2017 and entitled, “CONTROL OF CONTENT DISTRIBUTION,” which is hereby incorporated by reference in its entirety. This application is therefore entitled to a priority date of Jan. 24, 2017.

### TECHNICAL FIELD

Various of the disclosed embodiments concern content distribution. More specifically, embodiments of the invention concern control of content distribution.

### BACKGROUND

The music industry is broken. Music sales in the USA have dropped 44% from $26.6 billion in 1999 to $15 billion in 2015. The lost revenue is primarily the result of music piracy; however services such as YouTube™ and Spotify™ still offer “free music” instead relying on revenue from advertisements and/or subscriptions. The revenue generated by such services that is shared with the artists is often very low. For example, one million views will typically result in a payment to the artist of approximately $1,000 on Spotify™ and only $250 on YouTube™.

Despite the apparent diversity of music and video platforms, none of the existing platforms are fully dedicated to selling the content created by artists. Instead, services such as YouTube™, Spotify™, and Pandora™, all use content (e.g., music) as a pretext to create a large audience for their advertisements or subscriptions. This lack of focus on the content created by the artist explains the low levels of revenue that are typically shared with the artists and why prominent artists such as Adele, Taylor Swift, and others loudly complain about the unfair revenue sharing policies that exist in the industry.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 is a block diagram an example networked environment within which certain techniques described herein can be implemented;

FIG. 2 is a block diagram of an example architecture of the content distribution service 120 described with respect to FIG. 1;

FIG. 3 is a block diagram showing example interactions between components of the example architecture of FIG. 2;

FIG. 4 is a flow diagram showing an example artist dashboard workflow;

FIG. 5 is a flow diagram showing an example account module workflow;

FIG. 6 is a flow diagram showing an example project module workflow;

FIG. 7 is a flow diagram showing an example workflow for setting descriptions for content;

FIG. 8 is a flow diagram showing an example workflow for setting a distribution model for content;

FIG. 9 is a flow diagram of an example process performed by the content distribution service when a user tries to access a content;

FIG. 10 is a flow diagram of an example process for implementing an example distribution model;

FIG. 11 is a flow diagram of an example process for unlocking content;

FIG. 12 is a flow diagram of an example user interaction flow for an administrator user;

FIG. 13 is a flow diagram of an example user interaction flow for a mobile application;

FIG. 14 is a flow diagram of an example user interaction flow for navigating selections of content via the mobile application;

FIG. 15 is a flow diagram of an example user interaction flow for searching content via the mobile application;

FIG. 16 is a flow diagram of an example user interaction flow for navigating accounts setting via the mobile application;

FIG. 17 is a flow diagram of an example process for compression of uploaded content;

FIG. 18 is a flow diagram of an example process for synchronization between a local computing device and a remote content distribution service;

FIGS. 19A-19N show a series of screens of an example graphical user interface of the artist dashboard;

FIGS. 20A-20F show a series of screens of an example graphical user interface of the mobile application; and

FIG. 21 shows a diagrammatic representation of a machine in the example form of a computer system within which a set of instructions for causing the machine to perform one or more of the methodologies discussed herein may be executed.

### DETAILED DESCRIPTION

Various example embodiments will now be described. The following description provides certain specific details for a thorough understanding and enabling description of these examples. It will be appreciated that specific embodiments of the invention will be described herein for purposes of illustration, but that various modifications may be made without deviating from the scope of the invention. One skilled in the relevant technology will understand that some of the disclosed embodiments may be practiced without many of the disclosed details. Likewise, one skilled in the relevant technology will also understand that some of the embodiments may include many other features not described in detail herein. Additionally, some well-known structures or functions may not be shown or described in detail below, to avoid unnecessarily obscuring the relevant descriptions of the various examples. Accordingly, the invention is not limited except as by the appended claims.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this Detailed Description section.

### Overview

Artists are trying hard to negotiate better deals but, for them, the problem is more structural, so the solution must also be more structural. What the artists need is a platform specifically designed for them. Just like any other businesses, to make money artists need marketing, sales, and intellectual property (IP) protection. Disclosed embodiments proceed with the notion that marketing and sales should be more social media centric because this is the best place to find an artists' targeted audience. Also, disclosed embodiments proceed with the notion that IP protection is essential and should focus on preventing or limiting illegal downloads at the early moments of a new release.

Disclosed herein is a computer-implemented marketplace-as-a-service (MAAS) for distributing digital content that addresses the problems of traditional content distribution models. As used herein, the term digital content refers to any type of digital content such as audio, video, images, multimedia, executable software, etc. In certain instances, reference is made to content items. A content item in this context refers to any individual piece of content (e.g., a file) or any logical grouping of content (e.g., multiple files). For example, a content item may include an audio file of a music track. Similarly a content item may include a group of audio files constituting a selection of music tracks such as an album or playlist. In certain instances, reference is made to “accessing content” and/or “enabling access to content.” It shall be understood that the manner in which content is accessed will depend on the type of content. For example, “accessing a content item” may include any of downloading the content item, streaming the content item, playing content item, executing the content item, etc. Further, “enabling access to a content item” may include performing any associated steps to allow a user to access the content item. This may include playing the content item, causing the download of the content item, streaming the content item, executing the content item, unlocking the content item, displaying the content item, etc.

As will be described in greater detail, embodiments are disclosed that provide a new way for artists to promote and monetize their content, while being protected against piracy. For content producers, embodiments of the invention provide a powerful online customer relationship management (CRM) solution with an actionable dashboard for various entities involved in the production and distribution of content such as artists, managers, producers, record labels, etc. For consumers of the content, embodiments of the invention provide an application through which to access the content produced by artists. Access in this context may include listening to music, viewing videos, downloading the content to a local device, purchasing copies of the content, etc.

A new distribution model is disclosed that focuses on control by the artist on a per-content basis. Using the disclosed technique, an artist is able to fully control the distribution model applied for each of the pieces of content (e.g., music tracks) the artists creates. The artist controls what is free and what is not, the price point, the discounts, etc. while collecting real-time analytics with the possibility of making changes and adjustments in real time to fit a particular marketing and/or sales strategy. In an illustrative example, an artist may receive revenue streams (e.g. 50% of the net sales) from a provider that implements the MAAS platform.

Competitive platforms transform the “love of the fans” for the artists into advertisement revenues, while embodiments of the invention transform this into a real engagement leading to more exposure and more revenue for the artists.

The present disclose describes techniques for unlocking content using various options. For example, an artist can decide that a track is to be locked after two free streams per day. After the two free streams, end users may be required to unlock the track to continue access, for example, by purchasing the track (“Pay to Unlock”), or by sharing a post on a social media platform to promote the artist (“Share to Unlock”). This model allows users to pay for only the content they want while discovering new content in an environment that is free of advertisements and/or subscriptions.

Overall, the disclosed techniques represent an entertainment industry disrupter. The artist is his own distributor. In addition to providing a powerful tool for content consumers to discover new artists, innovative aspects of the present disclosure enable artists to take control of their career through managing the distribution of their creations all while interacting with their fans and developing strong partnerships with other entities such as record labels and majors that can push their careers to the next level.

### Example Operating Environment

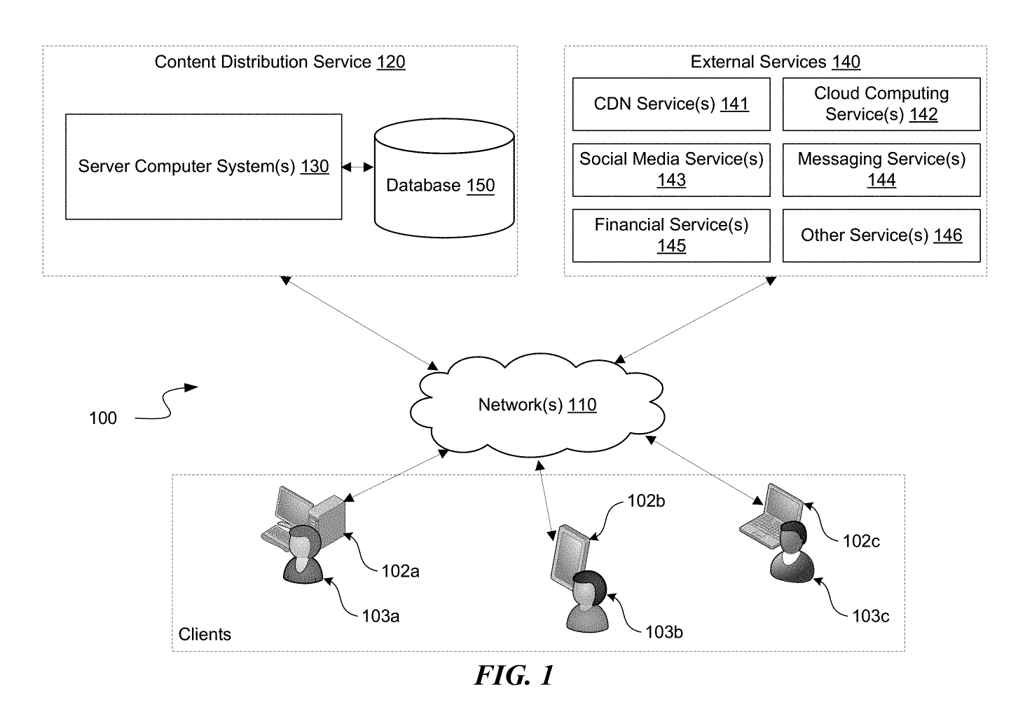

FIG. 1 shows an example networked environment 100 within which certain techniques described herein can be implemented. As illustrated in FIG. 1, the networked environment 100 may include a content distribution service 120 for implementing a content MAAS, one or more client computing devices 102a-c, and one or more external services 140. Entities (e.g., devices, users, software, etc.) associated with the aforementioned components of networked environment 100 may be communicatively coupled together via one or more communications channels, for instance communications networks 110 (e.g., LAN, WAN, Internet, Worldwide Web, cellular network, USB®, Bluetooth®, NFC).

The content distribution service 120 may represent any combination of hardware and or/software for executing instructions to carry out the functionalities described herein. For example, the content distribution service 120 may be implemented using one or more network connected server computer systems 130 (physical or virtual) with associated non-transitory processor-readable storage media or other data storage facilities. For example, one or more databases 150 for storing data (including metadata) maybe accessible to the server computer systems 130. Instructions for carrying out certain processes described herein may be implemented as software instantiated in a computer-readable medium or computer-readable storage medium on a machine, in firmware, in hardware, in a combination thereof, or in any applicable known or convenient device or system. This and other modules, sub-modules, or engines described in this specification are intended to include any machine, manufacture, or composition of matter capable of carrying out at least some of the functionality described implicitly, explicitly, or inherently in this specification, and/or carrying out equivalent functionality.

In some embodiments, the content distribution service 120 comprises an internet-based web service and/or a cloud-computing micro service. For example, content distribution service 120 may be implemented (at least partially) in instructions executed by computing entities in a cloud-computing environment. Such a cloud-computing environment may be hosted by a third-party cloud-computing provider. For example, Amazon™ offers cloud computing services as part of the Amazon Web Services (AWS) platform. One or more of the functionalities of the transaction content distribution service 120 may be implemented using products and services associated with a cloud-computing platform such as Amazon™ AWS. In an illustrative embodiment, computing functionality is provided using virtual computing entities (e.g., Amazon™ EC2 virtual server instances and or Lambda event-based computing instances) executing across one or more physical computing devices and storage functionality is provided using scalable cloud-based storage (e.g., Amazon™ S3 storage) and/or managed databases, data warehouses, etc. (e.g., Amazon™ Aurora, Amazon™ DynamoDB, Amazon™ Redshift, Google™ Spanner, etc.).

In some implementations, a user 103a-c may utilize a client computing device 102a-c to interact with the content distribution service 120 via network 110. For example, a client computing device 102a-c may execute an application or “app” that communicates with the content distribution service 120 via any suitable communications interface. In some embodiments, interaction between an application instantiated at a client device 102a-c and the content distribution service 120 may be via an application programming interface (API). Client computing devices 102a-c may include any number of types of devices configured to process data and communicate with other devices via network 110. Examples of such devices include desktop computers, laptop computers, smart phone devices, tablet devices, digital assistant devices (e.g., Amazon Echo™), wearable computing devices, smart televisions, video game consoles, etc. As will be described in more detail, users 103a-c may utilize client computing devices to interact with the content distribution service 120 in different ways. The term “users” in this context may refer to various types of entities operating with different roles with respect to the content distribution service 120 such as content creators (i.e. artists), content consumers (i.e., end-users listening to music or viewing videos), content publishers, service administrators, etc. For example, a content creator 103a may utilize a client computing device 102a (e.g., via a web portal) to upload content, develop projects, set distribution models for content, promote content, monetize content, interact with content consumers, etc. For simplicity, the term “content creator” is used in this context to refer to users on the production/distribution side of the content as opposed to the consumption side. The individual interacting with the content distribution system 120 in a production/distribution capacity may or may not be the actual artist behind the creation of the content. For example, a content creator user 103a may include an individual representing an artist that created the underlying content. A content consumer 103b, on the other hand, may utilize a client computing device 102b (e.g., via a mobile app) to search for available content hosted by the content distribution service 120, playback or view content, purchase content, share content, interact with content creators, etc. Further an administrator user 103c may utilize a client computing device 102c to curate content hosted by the content distribution service 120 (e.g., manage selections of content that are presented to content consumers 103b), manage user accounts, manage services, etc. Different types of users 103a-c are described in this disclosure for illustrative purposes. However, it shall be appreciated that each type of user 103a-c may refer to the same entity. For example, a entity interacting with the content distribution service 120 may do so as both a content creator 103a as well as a content consumer 103b. Accordingly, the terms: content creator 103a, content consumer 103b, administrator 103c, and users (generally) may be viewed interchangeably in this disclosure with respect to certain interactions, processes, workflows, etc.

While generally described below in terms of a user interface generated via instructions executing on a client computing device 102a-c, in some implementations the content distribution service 120 may serve as a user portal that may operate, for example, as a web server, serving HTML pages or providing web services which function as the user interface. Thus, in some implementations, the query processing system 120 serves as a user portal, providing a user interface, for instance a Web based interface, which allows users 103a-c access functionality disclosed herein via various processor-based computing devices 102a-c.

A user interface displayed on the display at any of computing devices 102a-c may include various pull-down menus, tabs, user selectable icons, input fields, scroll bars, images, videos, audio, and dialog boxes, as well as other user interface components. The user interface may allow a user 103a-c to create an account with the content distribution service 120 using a client computing device 102a-c. A user 103a-c may optionally enter financial account information, for instance an account number, expiration date, and validation or security code associated with a charge/debit or deposit account. This may allow automated charging/debiting for content purchased by content consumers 103b and/or payment to content creators 103a.

The various systems, subsystems, and/or processor-based devices are capable of communications, for example, via the one or more networks 110 which may be, for instance, packet switched communications networks, such as the Internet, Worldwide Web portion of the Internet, extranets, intranets, and/or various other types of telecommunications networks such as cellular phone and data networks or channels, and plain old telephone system (POTS) networks. The type of communications infrastructure should not be considered limiting. The communications networks 110 may take any of a large variety of forms, and may include modems (e.g., DSL modem, cable modem), routers, network switches, and/or bridges, etc.

While often illustrated as a single non-transitory processor-readable storage medium, in many implementations each of the various illustrated non-transitory computer-readable or processor-readable storage media may constitute a plurality of non-transitory storage media. The plurality of non-transitory storage media may be commonly located at a common location, or distributed at a variety of remote locations. Database(s) may be stored separately from one another on separate computer-readable or processor-readable storage medium or may be stored on the same computer- or processor-readable storage medium as one another. Various computer- or processor-readable storage medium may be co-located with the corresponding computer systems, for example, in the same room, building or facility. Alternatively, various computer-readable or processor-readable storage medium may be located remotely from the corresponding computer systems (e.g., server computer systems 130) for example, in a different facility, city, state or country. Electronic or digital information, files or records or other collections of information may be stored at specific locations in non-transitory computer- or processor-readable media, thus are logically addressable portions of such media, which may or may not be contiguous.

The networked environment 100 may also include one or more external services 140 that may be accessed by or integrated with the content distribution service 120, for example, via networks 110. “External” in this context refers to services generated, operated, managed, owned or otherwise provided by an entity other than a provider of content distribution system 120. In other words, external services 140 may include services offered by a third-party such as Facebook® or Google® (e.g., via an API) that expands and/or off-loads certain functionalities described herein with respect to the content distribution system 120. As an illustrative example, content (e.g., in the form of audiovisual streams) may be delivered by content distribution system 120 to users 103a-b via one or more external content distribution network (CDN) services 141. As another example, and as previously described, certain computer processing and/or data storage functionalities may be offloaded to external cloud computing service 142 such as Amazon™ AWS. Interaction between users 103a-c, for example, to communicate or share available content may be handled by one or more external social media services 143 such as Facebook™ and/or one or more external messaging services 144 such as a short messaging service (SMS) or email by another provider. External services 140 may further include external financial services 145, for example, provided by a bank or card issuer. External services 140 may further include any other external services 146 that may be utilized to implement the functionalities described herein such as search engine services, e-commerce services, data analytics services, data storage services, cloud-computing services, location services, etc.

The external services 140 described with respect to FIG. 1 may be implemented using one or more server computer systems with associated non-transitory processor-readable storage media or other data storage facilities, for example similar to as described with respect to server computer systems 130 and associated facilities for storing and/or organizing data such as database 150. In some embodiments, portions of external services 140 may be implemented in hardware and/or software at content distribution service 120. A person having ordinary skill will recognize that the external services 140 depicted in FIG. 1 are examples provided for illustrative purposes. In some embodiments, content distribution service 120 may access fewer or more external services 140 than as depicted in FIG. 1 or may perform all functionalities internally and not access any external services 140 at all.

While FIG. 1 illustrates a representative networked environment 100, typical networked environments may include many additional computer systems and entities. The concepts taught herein may be employed in a similar fashion with more populated networked environments than that illustrated in FIG. 1.

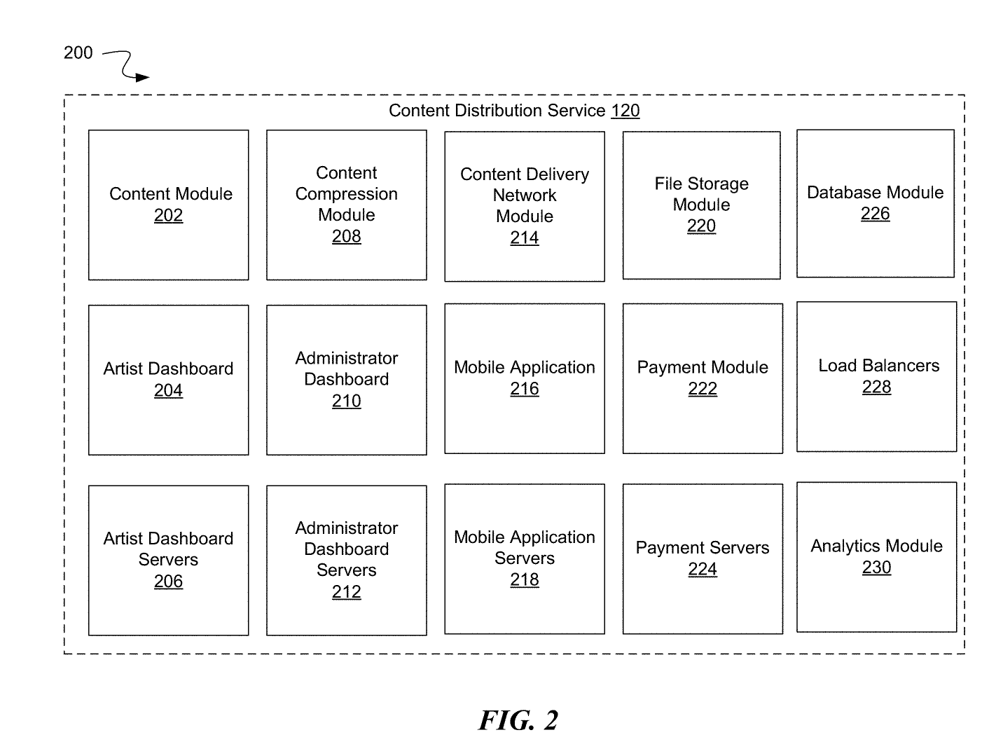

FIG. 2 shows a block diagram of an example architecture 200 of the content distribution service 120 described with respect to FIG. 1. As shown in FIG. 2, the content distribution service 120 can include multiple logical components that are implemented in software, hardware, or any combination thereof completely or partially at any of server computer devices 130, client computing devices 103a-c, and/or computing devices associated with external services 140. As shown in FIG. 2, the example architecture 200 includes a content module 202, an artist dashboard module 204, artist dashboard servers 206, a content compression module 208, an administrator dashboard module 210, administrator dashboard servers 212, a CDN module 214, a mobile application 216, mobile application servers 218, a file storage module 220, a payment module 222, payment servers 224, a database module 226, load balancers 228, an analytics module 230, and may include other modules that are not shown.

The content module 202 may include various sub-modules for presenting content to consumers of the content. For example, a content module may include an audio, video, image, and/or text sub-modules for encoding, decoding, rendering, displaying, or otherwise presenting various types of content. The content module may operate in conjunction with the content compression module 208 for compressing content for storage as well as a CDN module 214 for delivering content streams for presentation to users 103a-c at computing devices 102a-c.

The artist dashboard module 204 may comprise an interface through which artists create projects, upload content, promote the content, view analytics, etc. In certain embodiments, the artist dashboard 204 is implemented at least in part using a web-based application. The artist dashboard 204 may operate in conjunction with one or more artist dashboard servers 206 that support the content distribution service 120.

The administrator module 210, like the artist dashboard module 204, may comprise an interface through which an administrator manages the services of the content distribution service 120. In certain embodiments, the administrator dashboard 220 is implemented at least in part using a web-based application. The administrator dashboard 220 may operate in conjunction with one or more administrator dashboard servers 212 that support the content distribution service 120.

The mobile application 216 may comprise any type of application to facilitate the presenting of content to users 103a-c at client computing devices 102a-c. In certain embodiments, the mobile application 216 is downloadable to a client computing device 102a-c. In some embodiments, certain functionalities associated with the described technique may require communication between servers of the content distribution service 120 and the downloaded application 216 installed at a client computing device 102a-c. In some embodiments, the mobile application 216 is implemented as a “thin client” at a client computing device 102a-c meaning that the majority of the processing associated with certain functions are performed at remote computing devices associated with the content distribution service 120 instead of locally by the application 216 installed at the client computing device 102a-c. The application 216 may be platform agnostic, working with various platforms (e.g., Android, iOS, etc.) and/or software (e.g., operating systems such as Android, iOS or Microsoft Windows). The mobile application 216 may operate in conjunction with one or more mobile application servers 218 that support the content distribution service 120.

The file storage module 220 may handle the storage of content (audio, video, images, documents, etc.), user information, account information, payment information, configurations, and any other data by the content distribution service 120. In some embodiments, the files storage module 220 may operate to store data in one or more structured databases 226.

The payment module 222 may handle the processing of transactions by the content distribution service 120. The payment module 222 may operate in conjunction with payment servers 224 and external financial services 145 to process the purchasing of content and/or or credits by content consumers 103b. For example, content consumers 103b can purchase credits (i.e., add credits to a user account associated with the content distribution service 120) by drawing funds from an external account (e.g., a credit account, debit account, bank account, gift card, etc.). Similarly, the payment module 222 may operate in conjunction with payment servers 224 and external financial services 145 to process the payment of funds to content creators 103a based on purchases by content consumers 103b. For example, the content creator 103a can link their account with content distribution service 120 to an account with an external account (e.g., a bank account). When content consumers 103b unlock certain content created by a content creator 103a, credits or funds based on the generated revenue may be deposited in an account with the content distribution service 120 and/or automatically deposited in an external account associated with the content creator 103a.

Load balancers 228 may operate to balance workload between front-end and back-end systems (e.g., between dashboard modules and servers operating as part of the content distribution service 120).

The analytics module 230 may handle the tracking of content consumption (i.e., viewing/playback, purchasing, sharing, etc.), generation of analytics based on the tracking, and presentation of analytics information to certain users (e.g., content creators 103a) of the content distribution service 120.

It shall be appreciated that the example architecture 200 depicted in FIG. 2 is provided for illustrative purposes and is not to be construed as limiting. Other embodiments may include more or fewer components than are shown in FIG. 2 or may organize certain components differently.

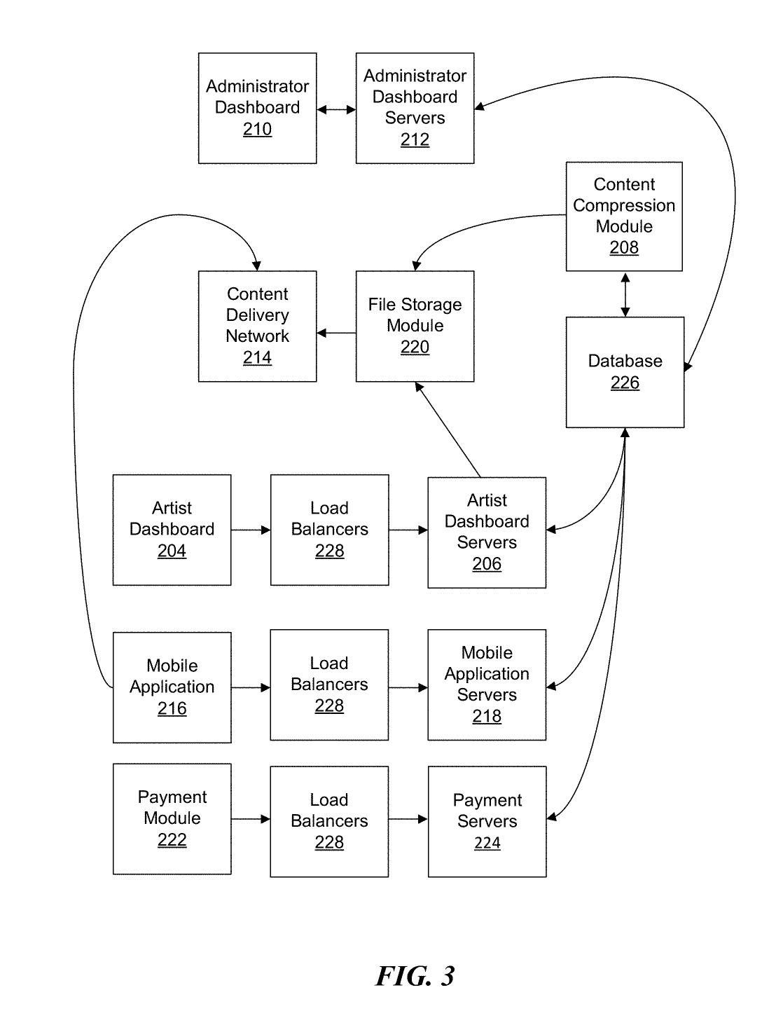

FIG. 3 shows a flow diagram illustrating example interactions between the example components of the architecture 200 depicted in FIG. 2. Again, the flow diagram is provided for illustrative purposes and is not to be construed as limiting. Other embodiments may organize interaction between components of the content distribution service 120 differently.

### Content Creator Workflows

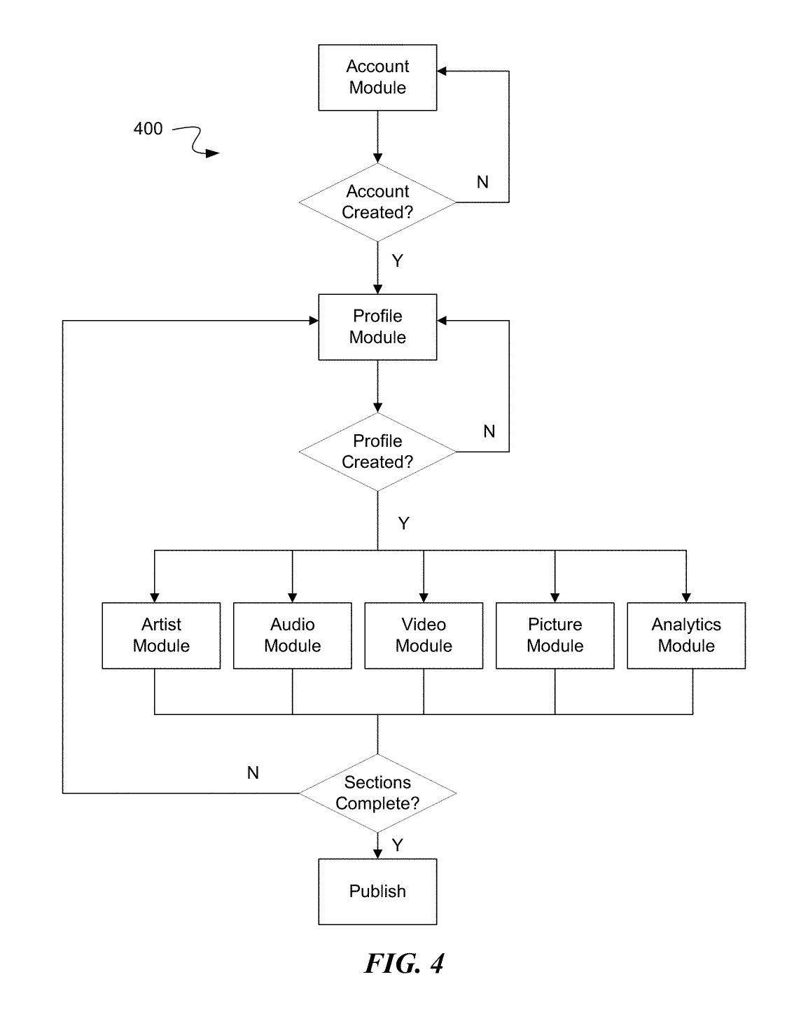

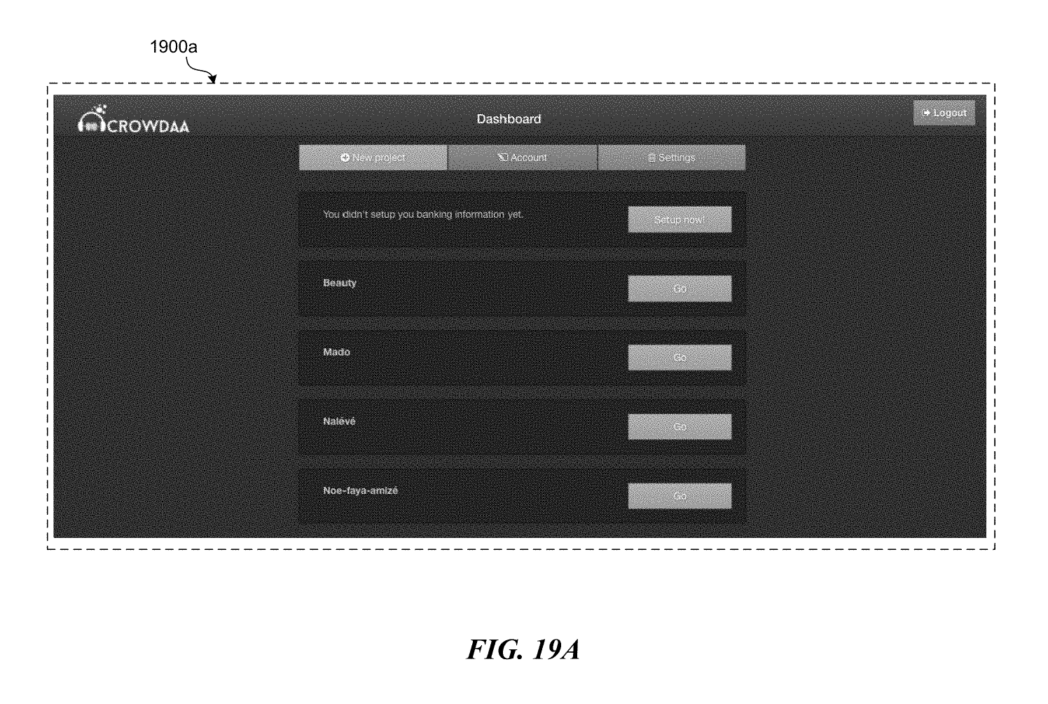

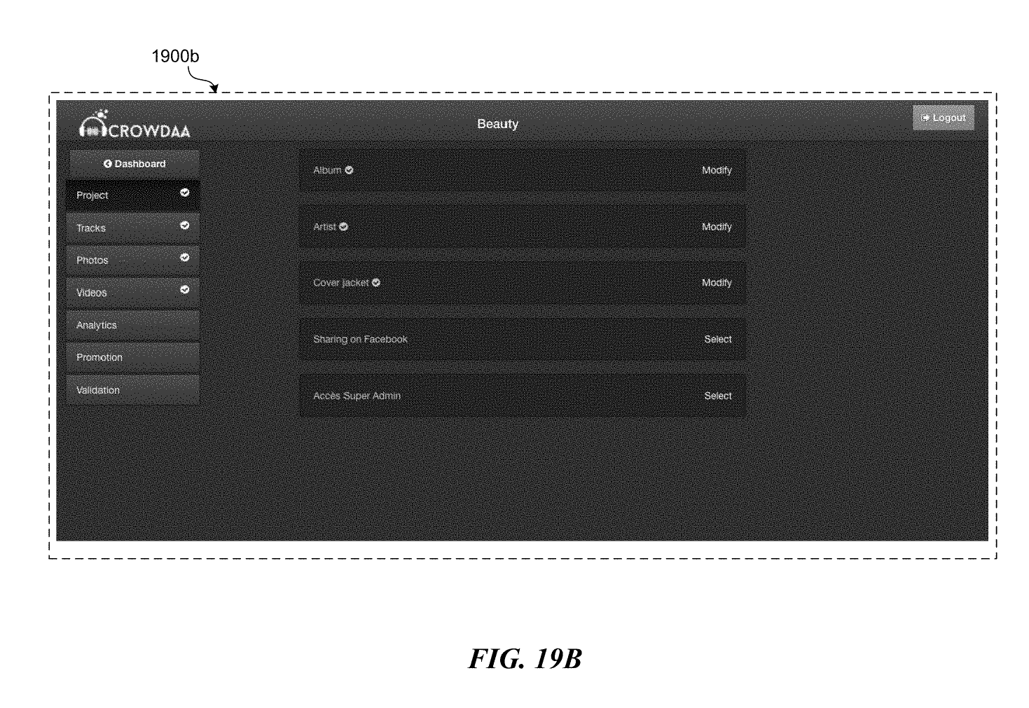

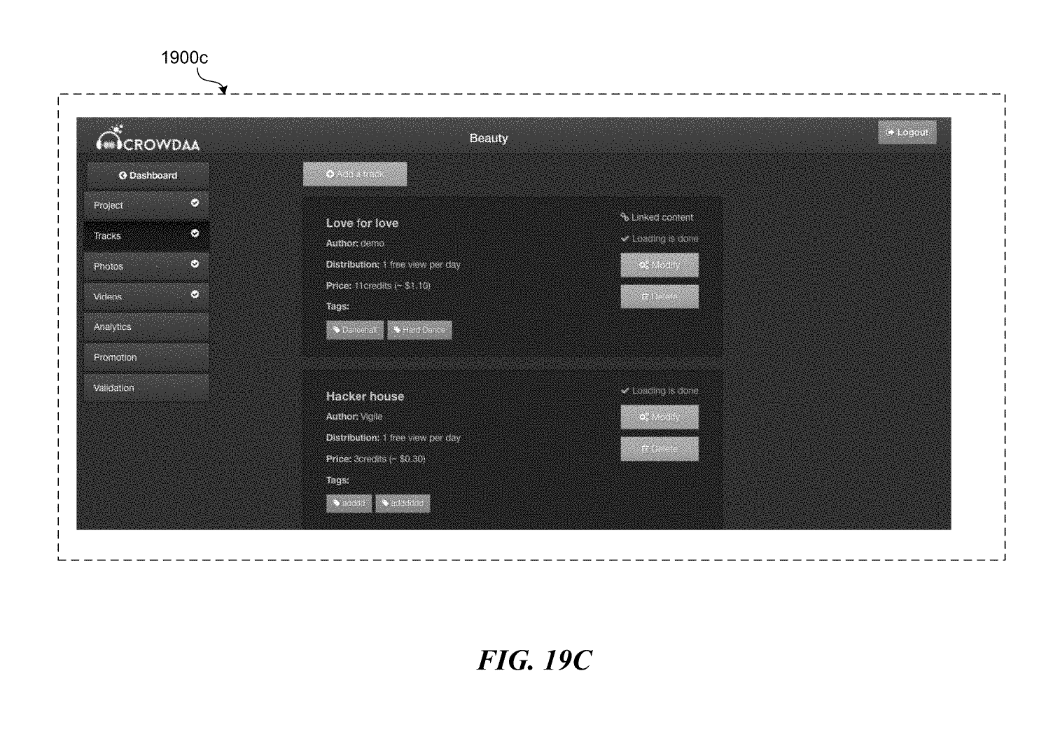

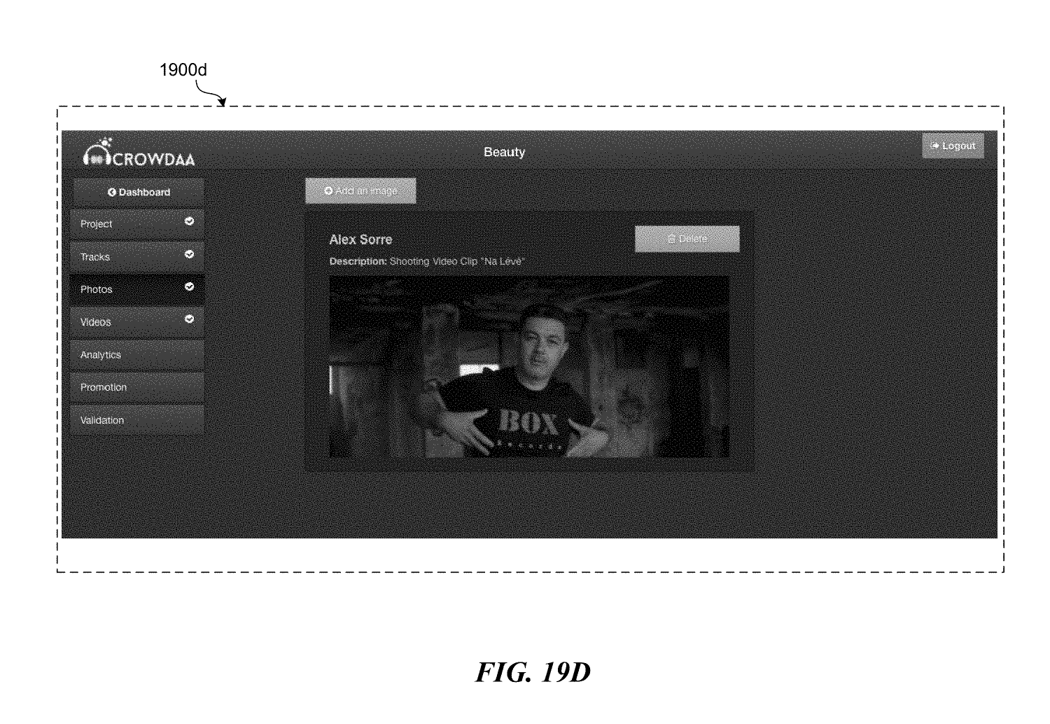

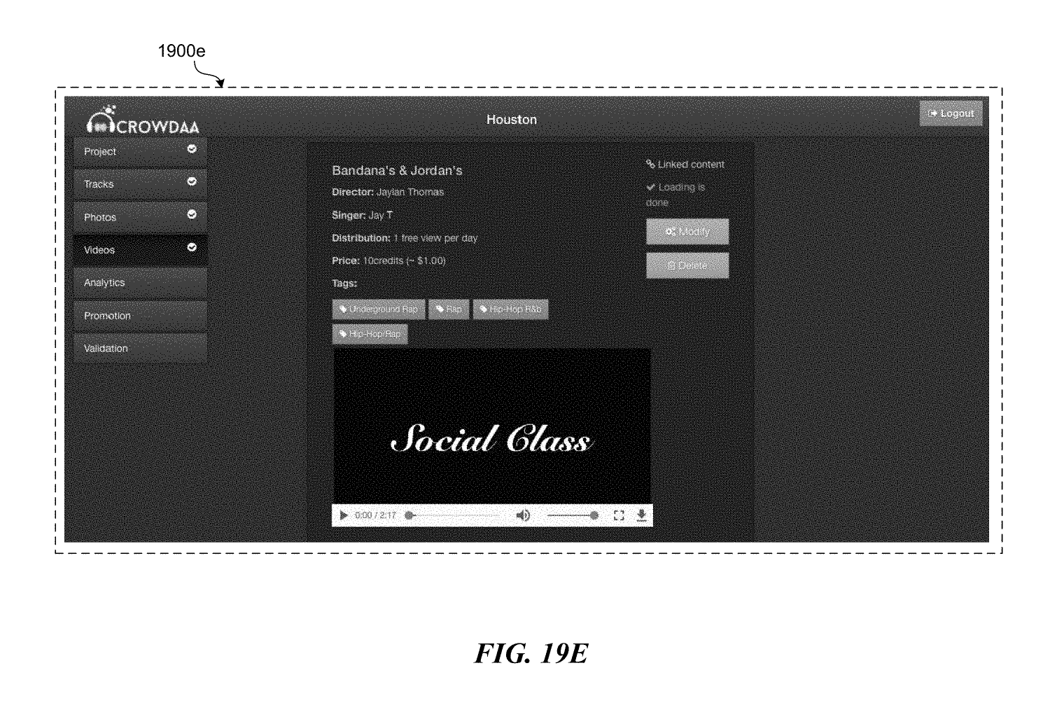

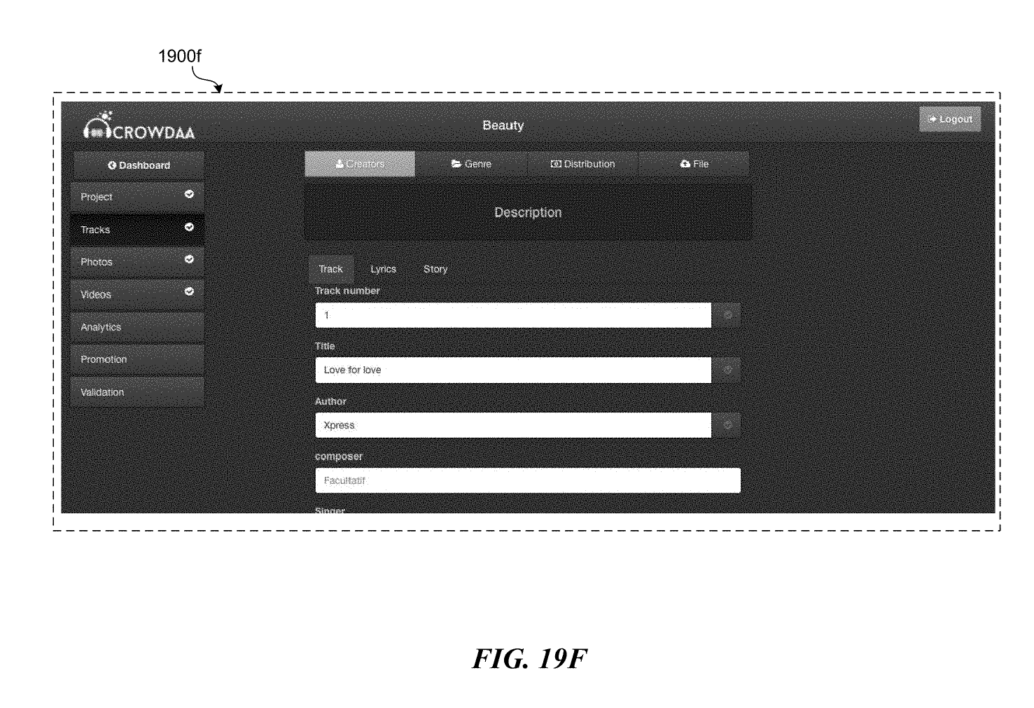

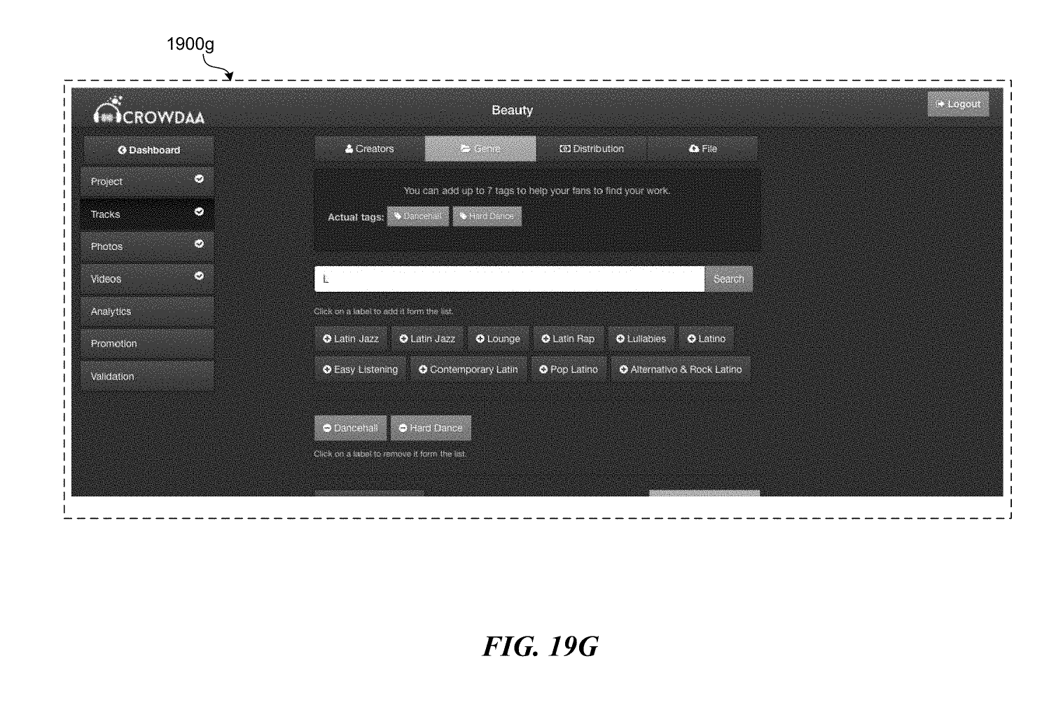

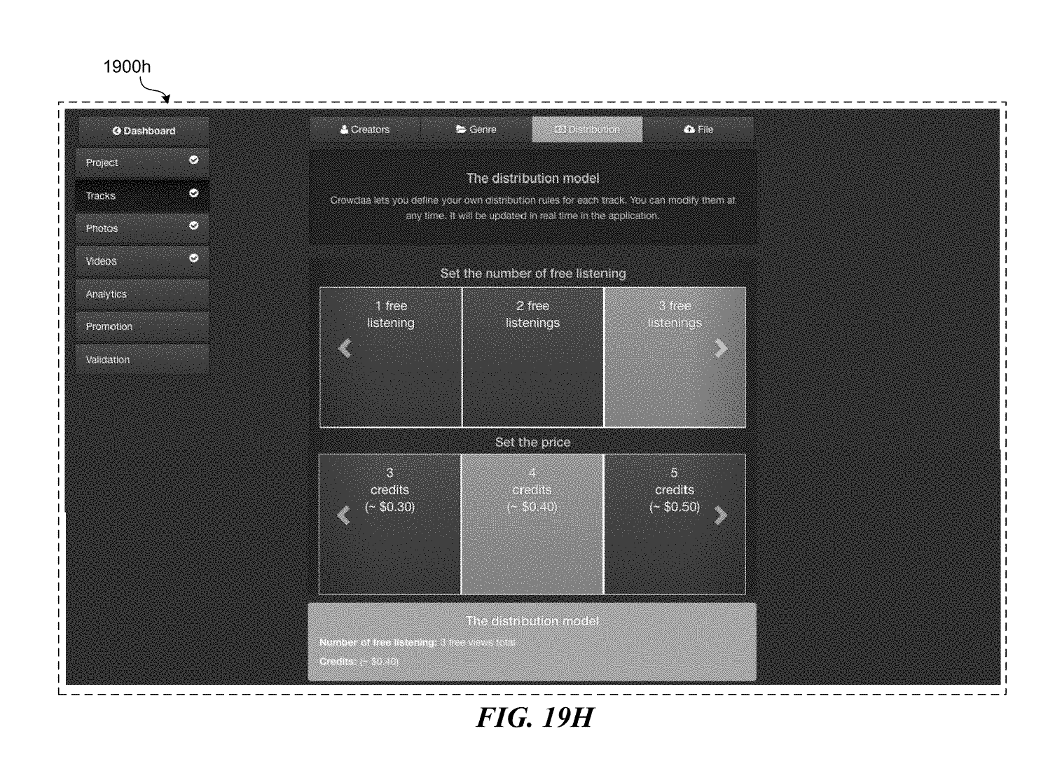

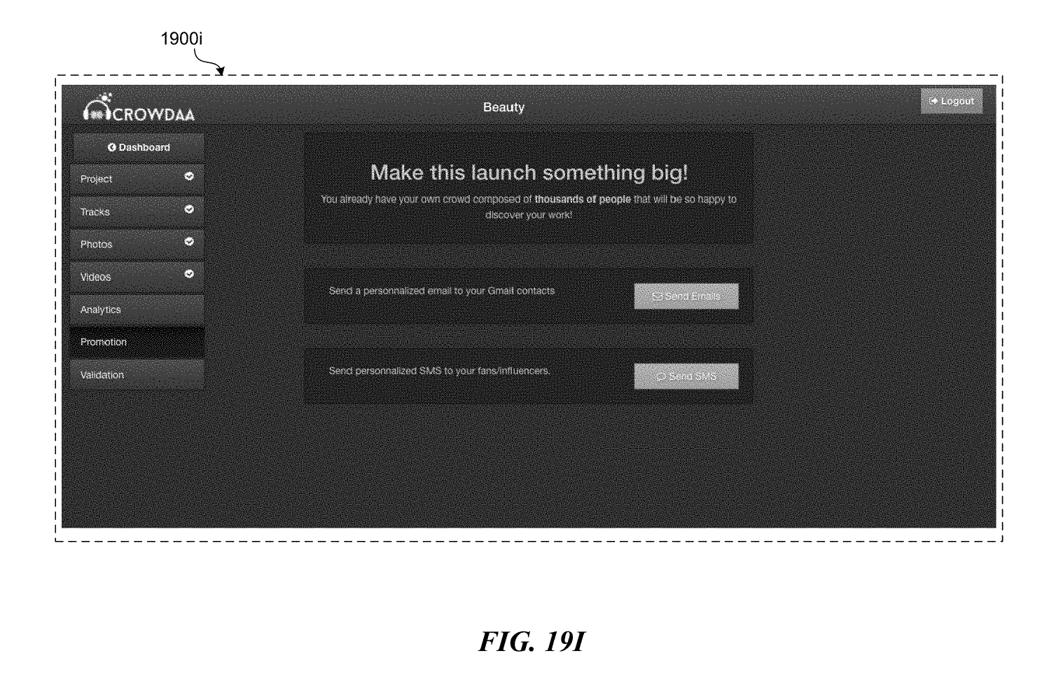

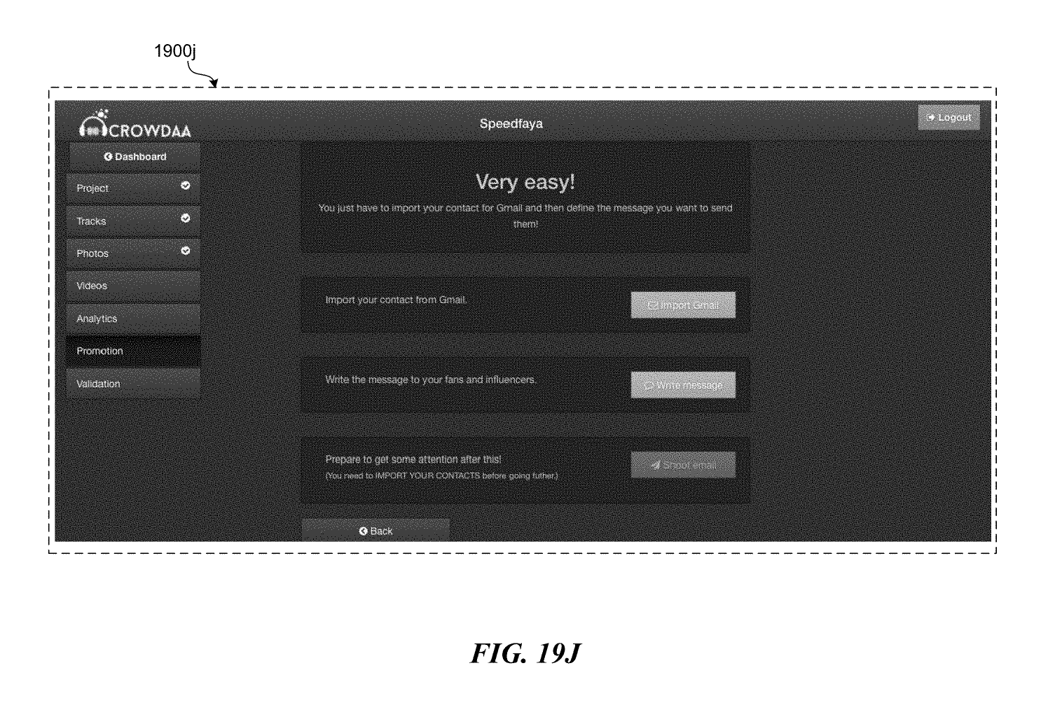

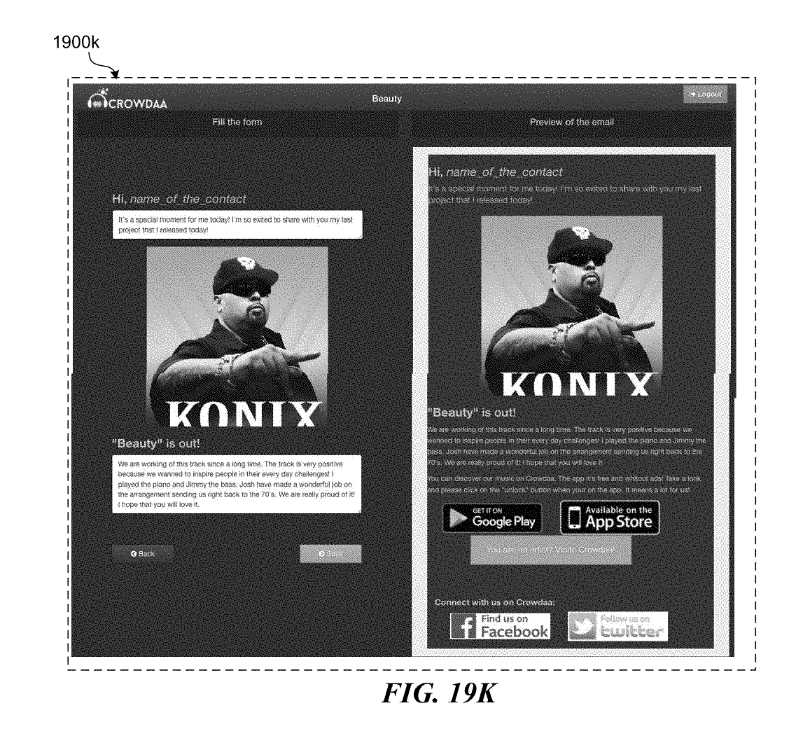

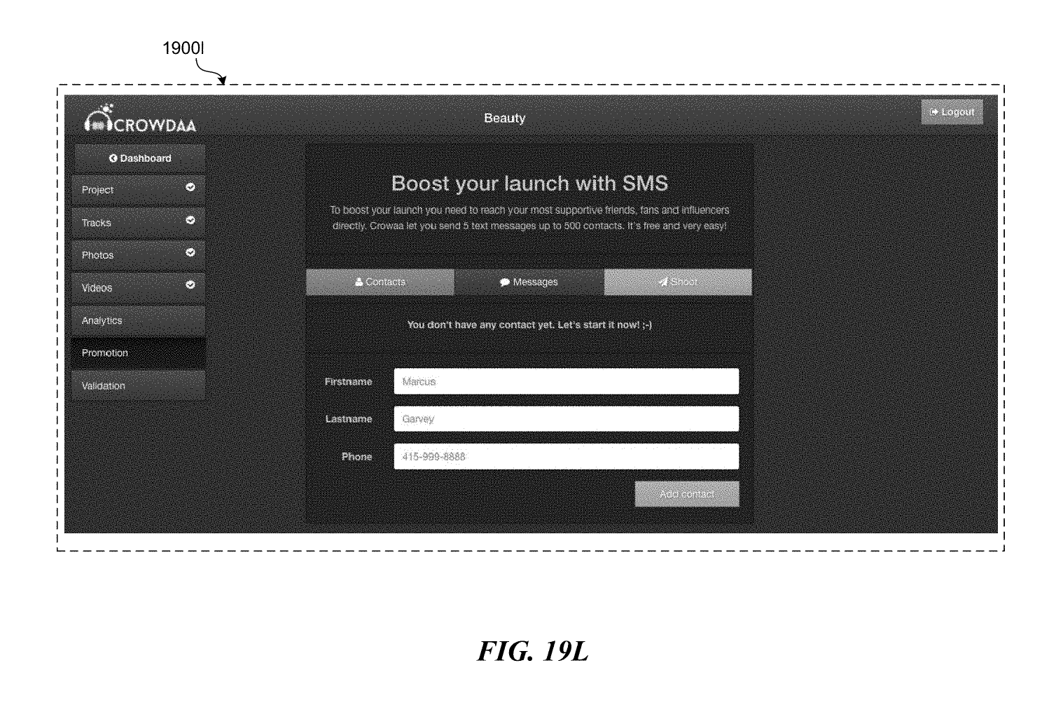

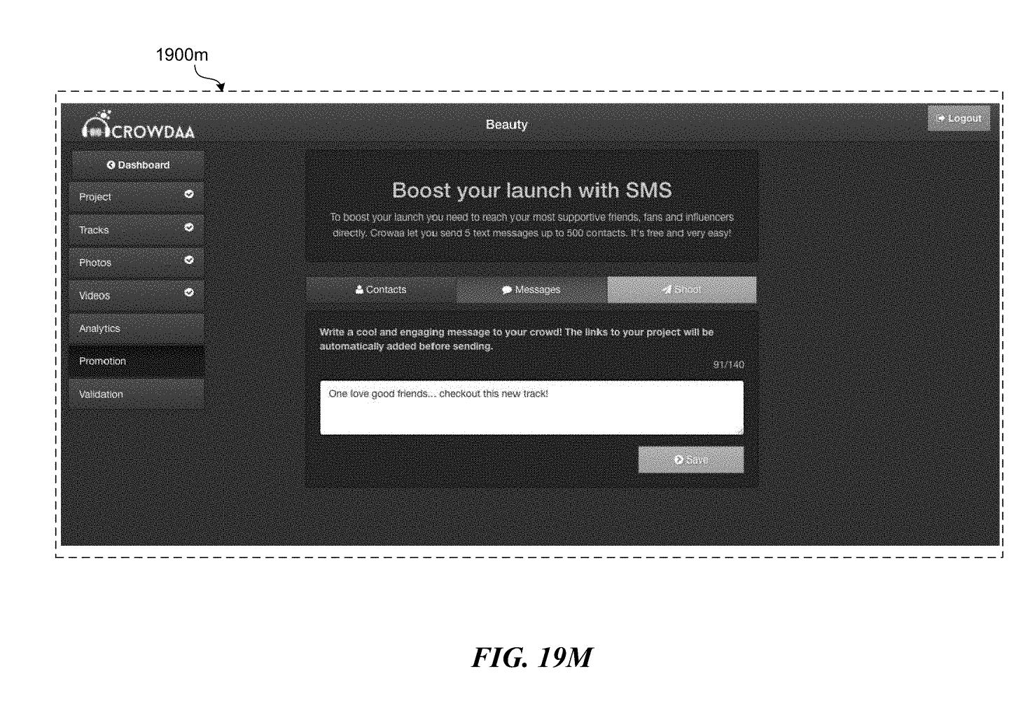

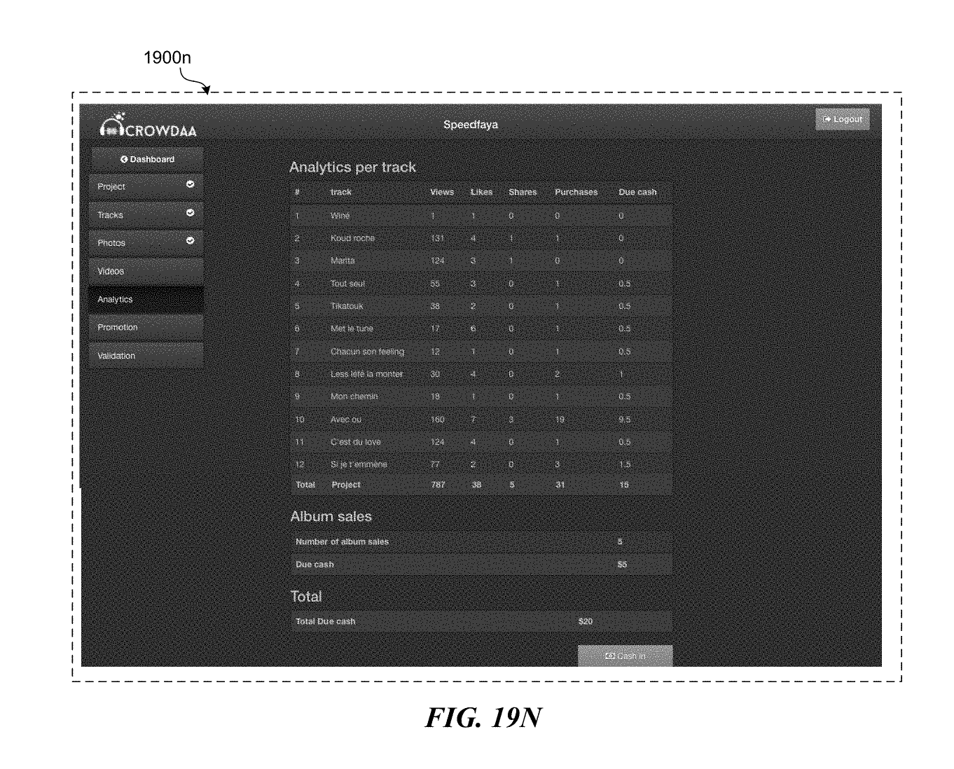

In an example workflow for a content creator 103a, the content creator 103a creates an account, uploads the content they have created, inputs information describing the content, and sets up a distribution model. As will be described in more detail, setting up a distribution model may include defining the number of times a content item can be played for free by a given user (i.e., a content consumer 103b) in a given time frame (e.g., per day), setting prices for content, setting unlocks for sharing, setting up discounts and promotions, and setting up any other automatic rules to apply as part of the distribution model. FIGS. 4-8 are flow diagrams of example interactions between a content creator 103a and the content distribution service 120, performed, for example, via an artist dashboard 204 associated with the content distribution service 120. Certain aspects of the interaction workflows are described with respect to the example artist dashboard graphical user interface (GUI) screens shown at FIGS. 19A-19N.

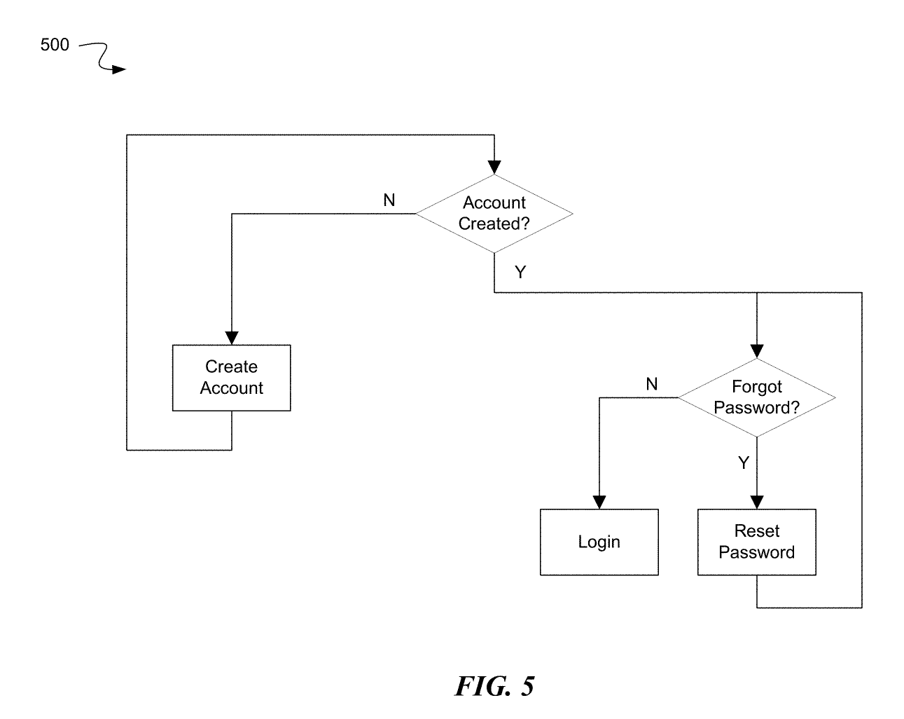

FIG. 4 shows a flow diagram of an example interaction workflow 400 through the artist dashboard 204. As shown in FIG. 4, example workflow 400 begins with determining by an account module if a user (e.g., a content creator 103a) interacting with the content distribution service 120 has created an account. FIG. 5 shows a flow diagram of an account module workflow 500 for creating an account if one is not already created and resetting a password if the password has been forgotten. Returning to the workflow 400 of FIG. 4, if the user has created an account a profile module determines if the accessing user has created a profile for a project that they wish to publish and if the user has defined information regarding the project.

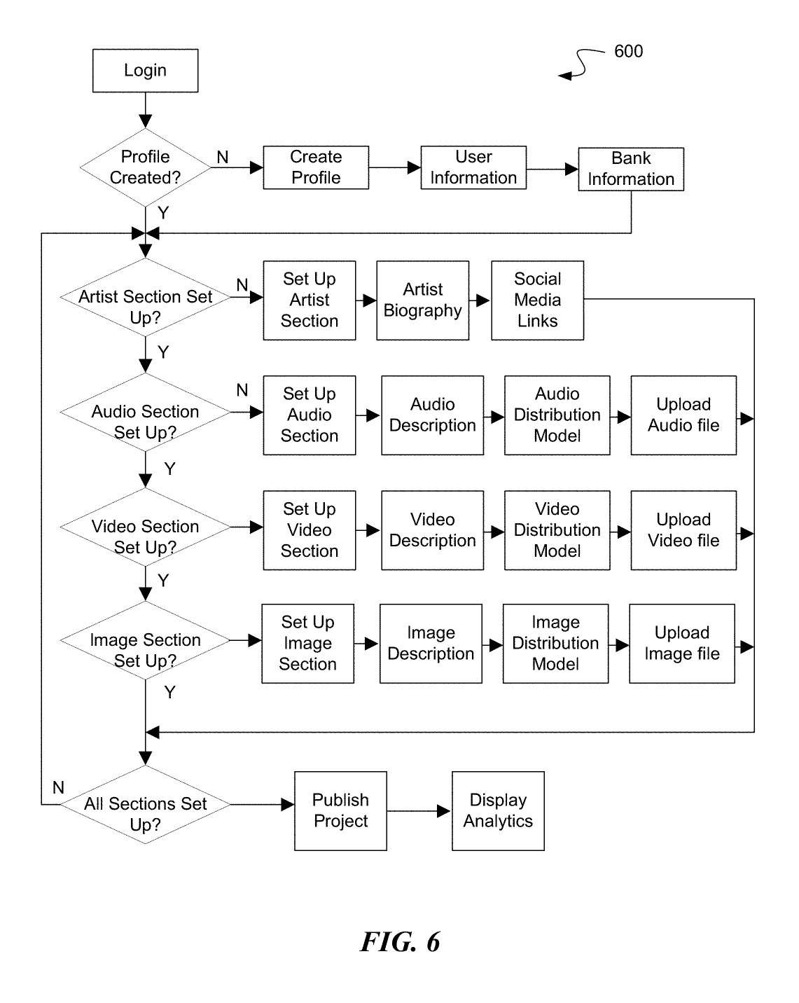

FIG. 6 is a flow diagram of a profile module workflow 600 that describes in greater detail various steps to creating a project to publish. As shown in FIG. 6, after a content creator 103a logs in, creates a profile and inputs their user information (e.g., name, password, preferences, linked bank account, etc.), the service 120 may enable the content creator 103a to set up a project that may include various types of content. For example, as shown in FIG. 6, a user can initiate a process to setup an artist associated with the content, setup audio content (e.g., music), setup video content (e.g., movies, music videos, etc.), and setup images (e.g., photographs, paintings, etc.). For each content item the content creator 103a wishes to include in a project the process may include initiating the setup of the content, entering a description for the content, setting up a distribution model for the content, and uploading the content.

As illustrative examples, FIGS. 19A-19E show example GUI screens 1900a-1900e of dashboard 204 through which a content creator 103a can manage their account and profile information, view their current projects, edit current projects, and create new projects. For example, FIG. 19A shows an example GUI screen 1900a of dashboard 204 that includes a listing of projects that are completed and published and/or in progress. Through this GUI screen 1900a, a user may select an existing project, for example, to view analytics, edit information associated with the project, set up promotions for the project, cash in revenues, etc.

Through GUI screen 1900a, a user may also initiate creation of new projects. In response to selecting an existing project or creating a new project via GUI screen 1900a, the user may be presented with GUI screen 1900b shown in FIG. 19B though which a user can enter and/or modify certain information associated with the project. For example, as shown in FIG. 19B, GUI screen 1900b includes interactive elements that a user can interact with to modify album information, artist information, cover jacket information, etc.

FIG. 19C shows an example GUI screen 1900c of dashboard 204 through which a user can add and/or modify information related to tracks included in a given project. For example, via GUI screen 1900b, a user may select the “tracks” option in the menu located on the left side of the screen and be presented with a listing of tracks included in the project, as shown in the GUI screen 1900c of FIG. 19C. As shown in FIG. 19C, each track listing may include information associated with the track (e.g., author, distribution model, price, revenue generated, tags, uploading status, etc.) as well as interactive options to modify information associated with the track (e.g., change the distribution model) and/or delete the track.

FIG. 19D shows an example GUI screen 1900b of dashboard 204 through which a user can add and/or modify information related to images included in a given project. Similar to GUI screen 1900c shown in FIG. 19C, GUI screen 1900d includes a listing of images included in the project as well as options to modify/delete current images and/or add new images.

FIG. 19E shows an example GUI screen 1900e of dashboard 204 through which a user can add and/or modify information related to videos included in a given project. Similar to GUI screen 1900c shown in FIG. 19C, GUI screen 1900e includes a listing of videos included in the project as well as options to modify/delete current videos and/or add new videos.

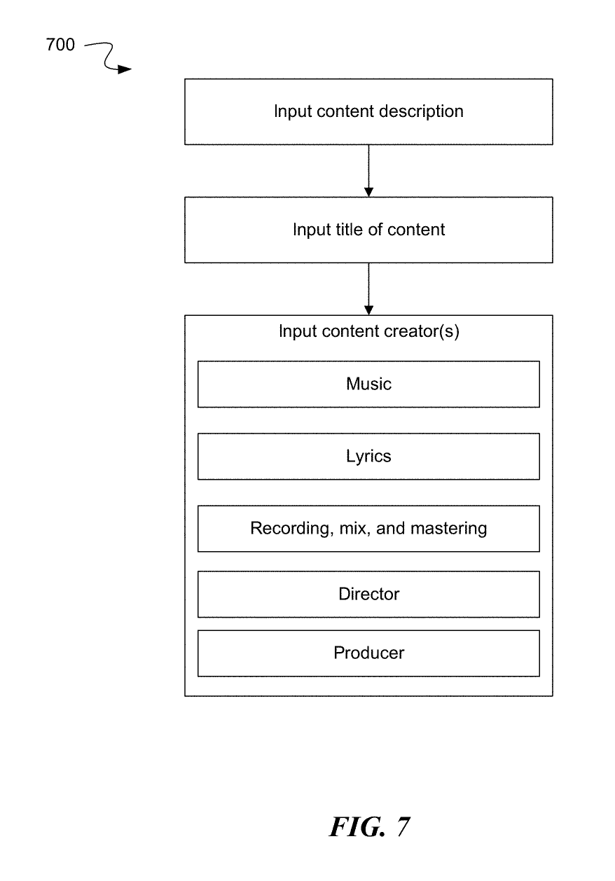

FIG. 7 is a flow diagram of an example workflow 700 for setting up a description of a content item. Depending on the type of content, this workflow may include inputting, by a user, a description of the content, a title of the content, and names of the one or more creators of the content. For example, in the case of a music track, the content creators may include a musical composer, lyrics creators, individuals involved in the recording, mixing, and mastering of the track, and a producer. In the case of video content, the content creators may include a director, editors, special effects artists, etc.

As an illustrative example, FIG. 19F shows an example GUI screen 1900f of dashboard 204 that includes interactive elements in the form of editable text fields through which a content creator 103a can input information to set up a description of a content item. In the example screen 1900f depicted in FIG. 19F, a user is entering information for a track including a track number, title, author, composer, etc. The user may similarly select options via the GUI screen 1900f to enter lyrics and a story regarding the track.

FIG. 19G shows an example GUI screen 1900g of dashboard 204 that includes interactive elements for setting tags (e.g., genre tags) for pieces of content. Such tags may be utilized to aid in a search feature presented to content consumers 103b via the mobile application 216. As suggested in FIG. 19G, a content creator 103a can add multiple tags, for example indicative of musical genre, to each track. In some embodiments, the content creator 103a selects from pre-existing tags generated by the content distribution service 120. For example, GUI screen 1900g depicts a search bar through which a content creator 103a can search for pre-exiting tags. Alternatively, the content creator 103a may generate custom tags for tracks that are then added to a central database of tags and made available for use by other content creator users.

Returning to the workflow 600 of FIG. 6, once the content creator 103a has set up one or more of the various sections of a project (i.e., artist, audio, video, picture, etc.), they can proceed to publish the project via the content distribution service 120 to be made available for access by other users (i.e., content consumers 103b). Publication, may in some embodiments, including setting up a promotion program to get the word out to other users about the project, for example, via text messaging and/or email.

As illustrative examples, FIGS. 191-19M show example GUI screens 1900i-1900m of dashboard 204 through which a content creator 103a can set up a messaging campaign to promote the content they have uploaded. Specifically, FIG. 19I shows an example GUI screen 1900i through which a content creator 103a can elect to promote a project and/or individual pieces of content, for example, through an email or text messaging campaign. For example, via GUI screen 1900b, a user may select the “promotion” option in the menu located on the left side of the screen and be presented with a listing of options to promote the project, for example, as shown in GUI screen 1900i.

If the content creator 103a elects an email campaign they may be presented with example GUI screen 1900j shown in FIG. 19J, which includes options to import contacts from an external email service such as Google Gmail™, generate an email message, and send the generated email message to certain contacts.

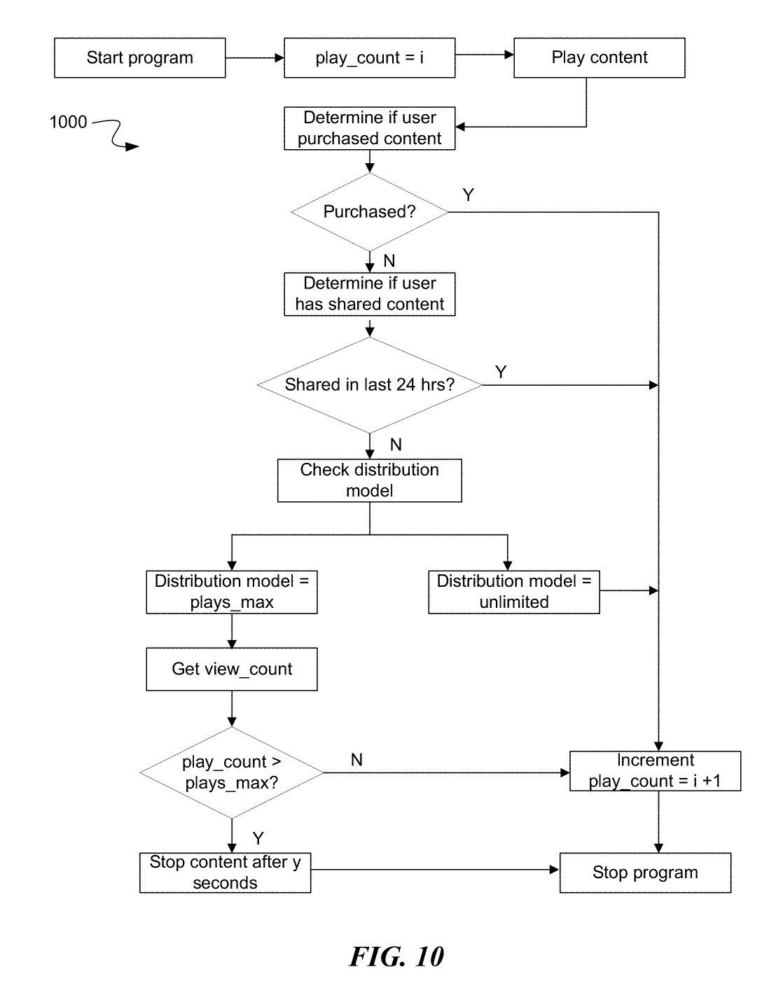

In response to selecting an option via GUI screen 1900j to generate an email message, the content creator 103a may be presented with example screen 1900k shown in FIG. 10K, which includes an interface for generating an email messages (including text and graphics) as well as a preview of the email message as it will appear to recipients. As shown in FIG. 19K, the email message sent as part of the promotional campaign may include links to online application or “app” stores such as the Apple App Store™ through which recipients may download the mobile application 216 in order to accesses the promoted content.

If the content creator 103a elects a text message campaign they may be presented with example GUI screen 19001-1900m shown in FIGS. 19L and 19M, which includes options to input information for generating text messages. For example, as shown in FIG. 19L, options may include interactive elements in the form of editable text fields to input recipient identifiers such as names and phone numbers to a listing of contacts. Similarly, editable text fields are included in example screen 1900m through which the content creator 103a can enter a text message to send to selected recipients. In some embodiments, links to the promoted project and/or individual content are automatically added to text messages generated by content creator 103a before sending the text messages to the selected recipients.

As other users 103b view and listen to the published content, analytics are generated which may be viewed by the content creator 103a via the artist dashboard 204. As an illustrative example, FIG. 19N shows an example GUI screen 1900n of dashboard 204 that includes displayed analytics such as views, likes, shares, purchases, per-content revenue, and total revenue.

### Content Distribution Models

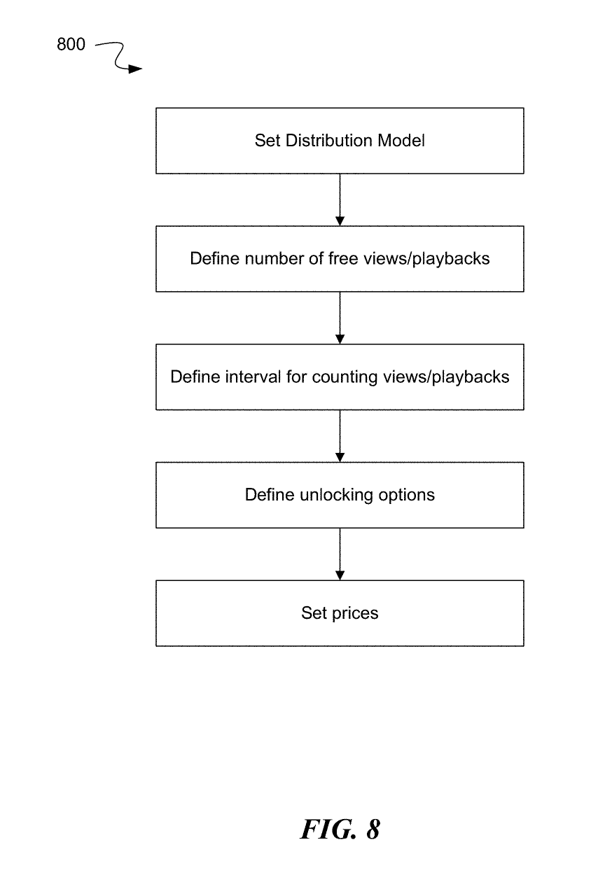

In some embodiments, a content creator 103a can set a distribution model for each content item. In general the Distribution model defines how the content can be accessed by other content consumers 103b. Examples of parameters associated with a distribution model include a quantity of free views/playbacks per time interval, the time interval length, options to unlock the content from view/playback restrictions, purchasing prices, etc. For example, FIG. 8 shows is a flow diagram of an example workflow 800 for setting up a distribution model for a content item, for example, via the artist dashboard 204. As an illustrative example, FIG. 19H shows an example GUI screen 1900h of dashboard 204 that includes interactive elements for setting certain parameters associated with the distribution model. For example, as shown in FIG. 19H, a content creator 103a can define a distribution mode by selecting one or more of a plurality of pre-defined conditions such as a number of free listens and setting a price to unlock the content. As will be described, the example options depicted in GUI screen 1900h represent only a few possible options that a content creator 103a may select from to define a distribution model for certain content.

In order to provide a content creator 103 greater control over how their content is accessed, the content distribution system 120 enables the content creator 103a to set different distribution models on a per-content basis. In other words, a content creator 103a can set a first distribution model for a first content item and a second distribution model for a second content item. As an illustrative example, a content creator 103a can upload a musical album containing multiple tracks to the content distribution service 120 and set different distribution models for each track in the album. In this example, the content creator 103a may set some tracks for unlimited free listening to encourage new listeners while limiting listening on other tracks to encourage new fans to purchase or share the tracks.

In response to the content creator's 103a inputs setting certain parameters of a distribution model for a particular content item, the content distributions system 120 may generate metadata indicative of the set distribution model parameters and may associate that metadata with the uploaded content data. In some embodiments this metadata may appended to the same file as the uploaded content and/or may be stored as a separate set of data, for example, in a database associated with the content distribution service 120.

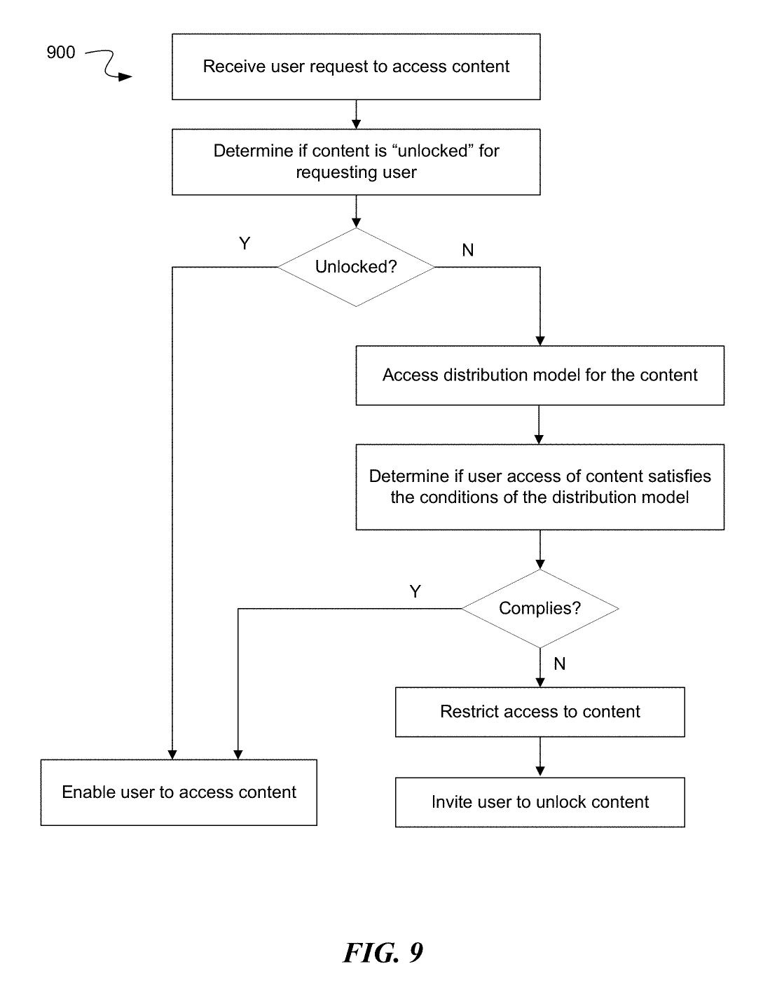

When a content consumer 103b attempts to access a published content item, for example, via a mobile app, the content distribution service 120 performs a process to determine whether to enable access to (i.e., play or display) the content item. FIG. 9 is a flow diagram of an example process 900 performed by the content distribution service 120 when a user (e.g., a content consumer 103b) tries to access a content item. As shown in FIG. 9, example process begins with receiving a user request to access a content item. For example, the user request may be based on a detected interaction with a GUI at the mobile app. In an illustrative example, the user request may be based on a content consumer 103b selecting a track to play.

In response to receiving the user request, example process continues with determining if the content item that the user is requesting access to is unlocked for the user. The content may be unlocked, for example, if the user previously purchased the content. The step of determining if the content is unlocked may include accessing any data indicative of the unlocked state of the content. This data may be in the form of an entry in a database associated with the content item and an account of the requesting user. Such data may be stored at a centralized database associated with the content distribution service 120 and/or locally at the client computing device of the requesting user. In embodiments in which this information is stored both remotely and locally, the system may be configured to favor the information stored remotely at the centralized database if the information is not the same (e.g., due to de-synchronization).

If the content is determined to be unlocked for the requesting user, process 900 continues with enabling access to the content for the requesting user. Enabling access may include, for example, allowing the user to download a copy of the content and/or transmitting a stream of the content and causing the client computing device of the requesting user to present (e.g., display or playback) the content stream.

If the content is determined not to be unlocked for the requesting user, process 900 continues with accessing information associated with the distribution model set for the content by the content creator 103a, for example, as previously described. Recall that a content creator 103a can set distribution model parameters that govern access to a content item that has not been unlocked for a particular user. For example, the distribution model parameters for a musical track may be set to allow three free plays per 24 hour period with options to unlock the track by purchasing for a particular amount or sharing with other users (e.g., via social media). Note that this is just an example provided for illustrative purposes. Depending on the implementation, a content creator user 103a may have the option to set other types of conditional parameters such as geographic conditions (e.g., free plays authorized at a particular location such as a café), device conditions (e.g., free plays authorized on a particular operating system such as iOS), promotional conditions (e.g., unlimited free plays allowed during a promotional period), etc.

Process 900 continues with determining if the requested user access satisfies the distribution model set for the content item. In an embodiment in which the distribution model allows a particular number of free plays per time period, this step may include determining how many times the requesting user has accessed the content item over the defined time period. In this example, if the number of plays by the requesting user is below the number of free plays authorized by the distribution model, the content distribution service 120 enables access to the content item (i.e., allows the requesting user to play it).

If requested access by the user does not satisfy the conditions of the distribution model (e.g., if the number of plays is at or above the number of free plays authorized by the distribution model), the content distribution service 120 restricts access to the content. Restricting access may include preventing the content from playing or be viewed at the computing device of the requesting user, playing or displaying a lower quality version of the content (e.g., a low resolution video or low bitrate audio), playing or displaying the content for a limited period of time (e.g., a few seconds) before stopping playback/viewing, or any other mode of providing less than full access than if the content were unlocked.

In some embodiments, if the requested access by the user does not satisfy the conditions of the distribution model, process 900 may continue with inviting the user to unlock the content, for example, through purchasing the content or sharing the content with other users. In some embodiments, if the user purchases the content, the content is downloaded automatically to the computing device of the user and stored within the mobile app. In such embodiments the purchased content may be accessible offline. A record of the purchase is stored in the central database. In some embodiments, if the user elects to share the content instead of purchasing, the content can be unlocked albeit for a limited time. In other words, the requesting user can playback or view the content an unlimited number of times within the limited time period. In some embodiments, the limited period of time is, by default, 24 hours; however a content creator 103a may be allowed to set alternative time periods when setting the distribution model. When the content is shared to unlock it may be only available through streaming as opposed to download option when purchased.

FIG. 10 is a flow diagram of an example process 1000 for a particular embodiment of a distribution model. In the example depicted, the content can be unlocked by purchasing the content or sharing, and the distribution model can be set for unlimited play (i.e., free) or for a maximum number of plays. The example, process begins with initiating a program associated with the distribution model in response to a user clicking on a content via the mobile app. The user's current number of plays of the content is represented in the flow diagram by the variable “play_count” which at the beginning of the process 1000 has value “i.”

In response to the user clicking the content, process 1000 continues with playing the content via the mobile application 216 at the user's computing device. Process 1000 continues with determining if the user has already purchased the content, for example, by inspecting an indicator (e.g., metadata) stored in a central database associated with the content distribution system 120 and/or in the mobile application 216 at the user's client computing device. If an indicator at the central database does not conform with an indicator at the user's computing device, process 1000 may default to relay on the indicator at the central database.

If the user has already purchased the track, process 1000 continues with incrementing the number of user plays such that “play_count=i+1” and continuing to play the content.

If the user has not already purchased the track, process 1000 continues with determining if the user has shared the track with others, for example, via social media. Specifically, in the embodiment depicted in FIG. 10, process 1000 continues with determining if the user has shared the track with others in the last 24 hours. Such information may be stored in a central database of the content distribution service 120 and/or locally at the client device. As with the metadata indicative of a customer purchase, the system may be configured to default to the information in the central database if the two sources do not conform with each other.

If the user has shared the track with others in the last 24 hours, process 1000 continues with incrementing the number of user plays such that “play_count=i+1” and continuing to play the content.

If the user has not share the track with others in the last 24 hours, process 1000 continues with checking a distribution model associated with the track. As previously discussed, a distribution model may include any number of parameterized conditions set by a content creator 103a. In the example process 1000 depicted in FIG. 10, the number of different types of distribution models is limited to two for illustrative clarity: 1) a maximum number of plays; or 2) unlimited play. A person having ordinary skill in the relevant technology will recognize that other types of distribution models may also be integrated into process 1000. The distribution model associated with the track may be stored as metadata in the track file or as metadata otherwise associated with the track file. For example, if the content creator 103a set a distribution model for the track to a maximum of three free plays, this parameterized value (i.e., 3) may be stored as metadata associated with the track file. In this case, the distribution model setting a maximum number of plays is represented in the flow chart of FIG. 10 a variable value “plays_max.” Again, if the content creator 103a has set the distribution model to be a maximum of 3 free plays, plays_max=3.

If the distribution model allows for unlimited plays, process 1000 continues with incrementing the number of user plays such that “play_count=i+1” and continuing to play the content.

If, however, the distribution model allows for a maximum number of free plays, process 1000 continues with retrieving the current number of plays by the user (i.e., “play_count”) and comparing that value to the maximum number of free plays set by the distribution model. As previously mentioned, the play_count value may be stored in a central database of the content distribution service 120. In this example, the current number of plays by the user satisfies the condition set by the distribution model if play_count is less than or equal to plays_max. Conversely the current number of plays does not satisfy the condition set by the distribution model if play_count is greater than plays_max.

If the current number of plays by the user satisfies the condition set by the distribution model, process 1000 continues with incrementing the number of user plays such that “play_count=i+1” and continuing to play the content.

If the current number of plays by the user does not satisfy the condition set by the distribution model, process 1000 continues with stopping playback of the track immediately or after a period of time (e.g., a few seconds).

Although not depicted in the flow diagram of FIG. 10, an alternative distribution model may include a particular number of free plays in a given time period. For example, a distribution model may be set to limit free plays of the track to three per 24-hour period. In such an embodiment, process 1000 may continue with retrieving a current date and checking for a deadline associated with the content, for example, due to a user previously playing the track in the last 24 hours. A “deadline” in this context may be represented as a data object that associates a specific content, a number of plays for a given user and a limit date. If a deadline is associated with the track, process 1000 continues with retrieving the current number of user plays within the limit date and then comparing the number of plays within that limit date to the maximum allowed number of plays for the given period of time.

As previously explained, if the current number of user plays within the date limit is less than or equal to the maximum number of plays allowed based on the distribution model, process 1000 continues with incrementing the number of user plays such that “play_count=i+1” and continuing to play the content. If the current number of user plays within the date limit is greater than the maximum number of plays allowed based on the distribution model, process 1000 continues with stopping playback of the track immediately or after a period of time (e.g., a few seconds).

### Options to Unlock Content

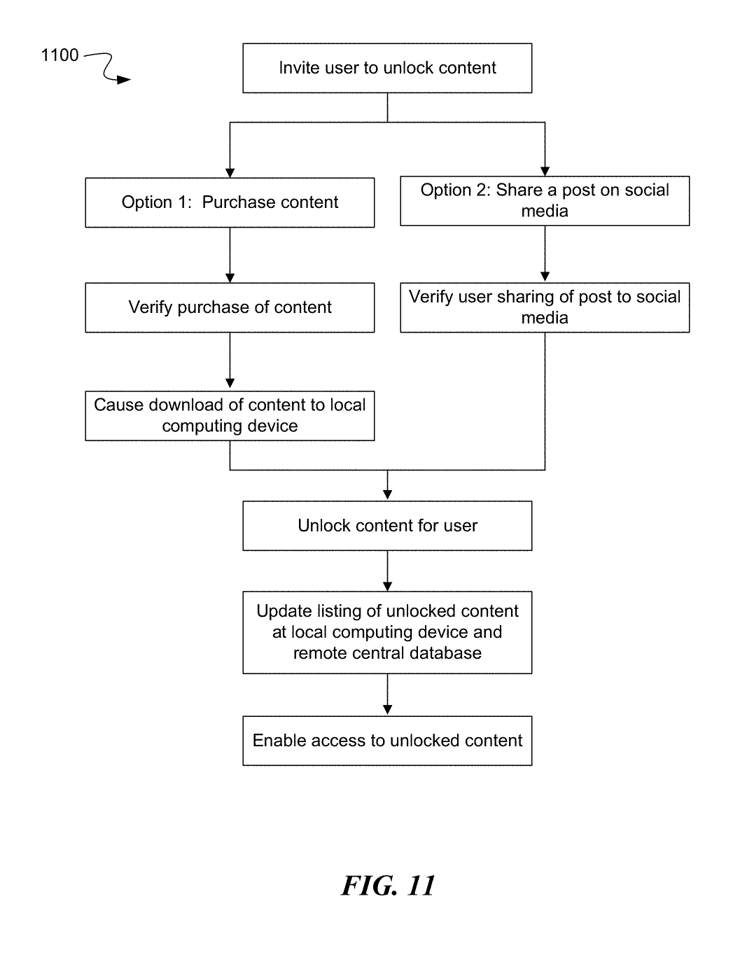

FIG. 11 is a flow diagram of an example process 1100 for unlocking content for a particular user. Recall that if the user has not already unlocked a content item, the example process 900 described with respect to FIG. 9 ended with inviting the user to unlock the content. As shown in FIG. 11, the user may be presented with several options to unlock the content. In the example process 1100 depicted in FIG. 11, the user can unlock content by either purchasing the content, for example, with previously purchased credits associated with the content distribution service 120 and/or by sharing a posting regarding the content via any one or more social media platforms such as Facebook™ or Twitter™.

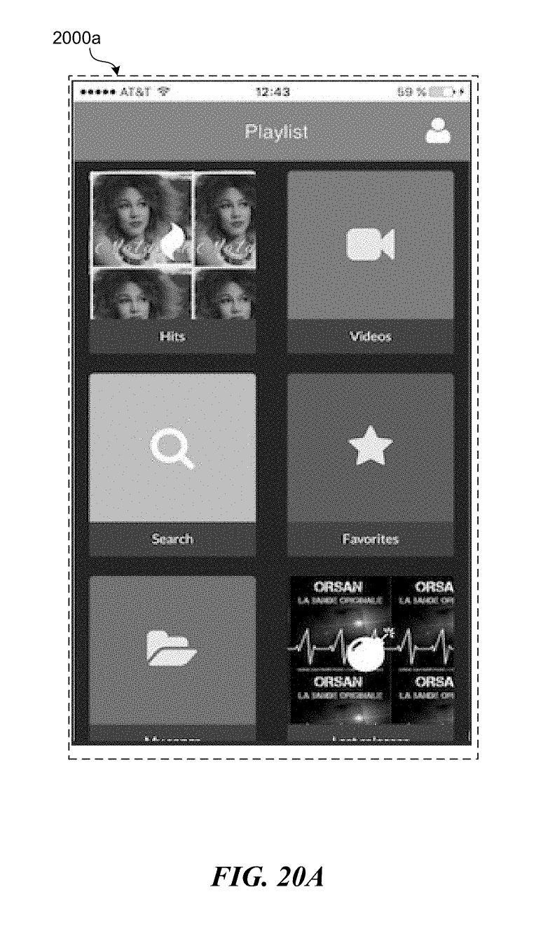

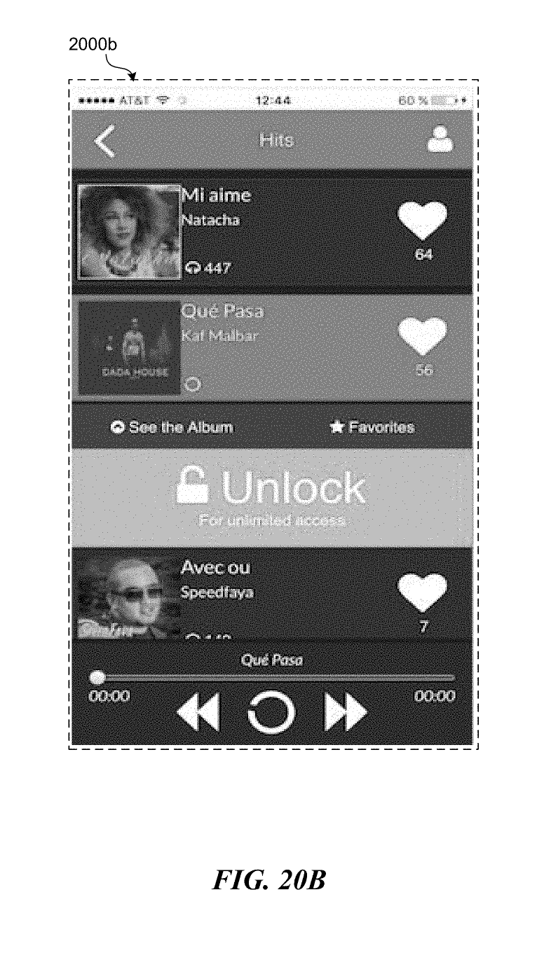

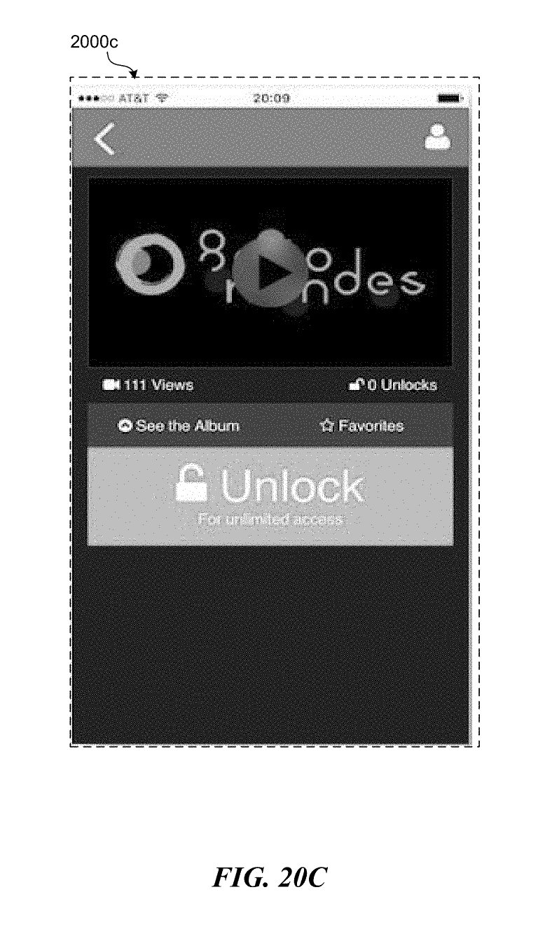

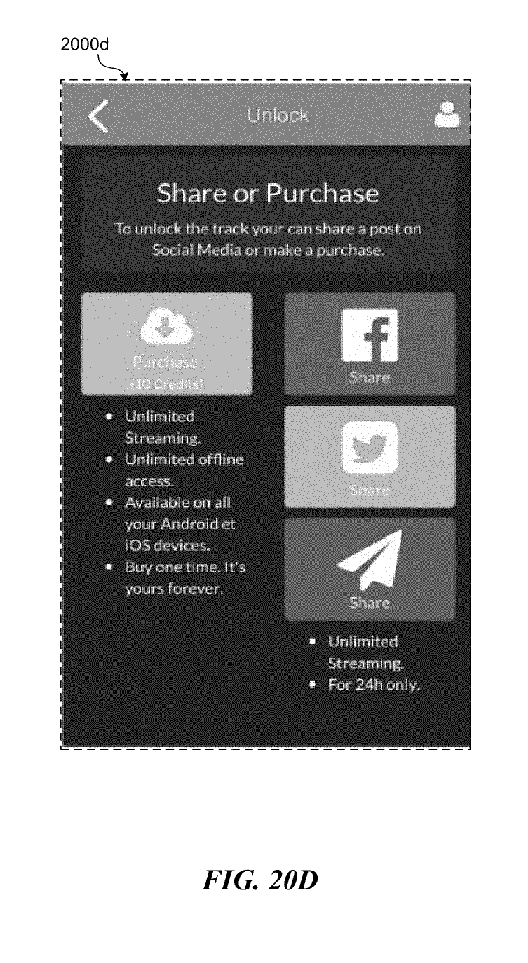

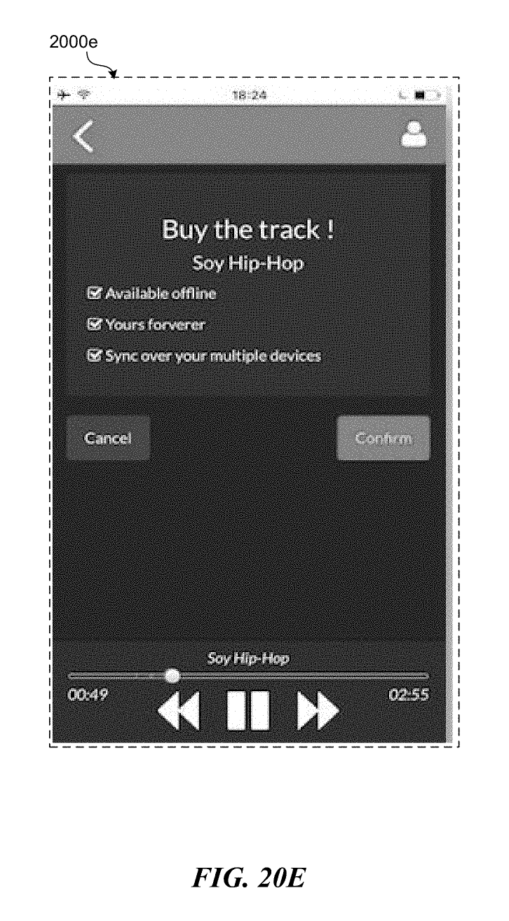

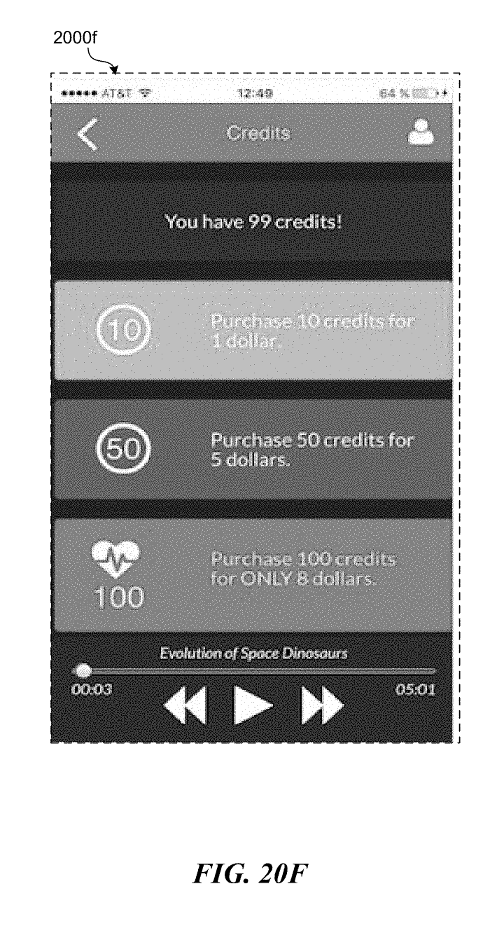

As an illustrative example, FIG. 20B shows an example GUI screen 2000b of mobile application 216 that includes an option to unlock a content item. For example, in response to selecting content listed in screen 2000b that a user has not yet unlocked, the GUI may change to include an option to unlock, for example, in the form of a button titled “unlock for unlimited access.” FIG. 20C shows an example GUI screen 2000c that is similar to example GUI screen 2000b except for selected video content. In response to selecting the options to unlock presented in example GUI screens 2000b and/or 2000c, the user may be presented with example GUI screen 2000d shown in FIG. 20D, which includes an option to unlock the content either by purchasing the content or sharing a posting related to the content.

If the user elects to purchase the content, process 1100 continues with seeking confirmation that the user wishes to purchase the content. As an illustrative example, FIG. 20E shows an example GUI screen 2000e that may be presented to the user via the mobile application 216 in response to the user selecting, via GUI screen 2000d, the option to purchase the content.

Assuming the user confirms the purchase, process 1100 continues with receiving payment of the purchase price (e.g., as set by the content creator 103a) and verifying the payment. In some embodiments, purchased content is automatically downloaded to the user's computing device or the user is provided the option to download the content to the computing device. As previously discussed, downloaded purchased content may be accessed offline by the user. In either case, the following verification of payment, the content is unlocked for the user, for example, by adding a content identifier associated with the purchased content to a listing of unlocked content associated with the user stored locally at the user's computing device and/or in a central database of the content distribution service 120. As with other information stored locally and remotely, the system may be configured to default to the listing stored in a central database if it does not conform with a listing at the user's computing device.

If the user elects to share a posting related to the content, process 1100 continues with verifying the posting by the user. Sharing a posting in this context can include posting a message via any of several social media platforms. In some cases the message may include a link for another user to access the content being shared via the content distribution service 120. Verification of the user's posting may be accomplished several different ways. In some embodiments, the mobile application 216 presents embedded links that enable direct posting to a social media platform, for example, via an API associated with the social media platform. The example GUI screen 2000d shown in FIG. 20D includes several interactive graphical elements to share, for example, via Facebook™ or Twitter™. These interactive graphical elements may link to the special media platforms via their respective APIs such that when a user selects the option to share via the GUI of the mobile application 216, that user is automatically directed to the appropriate social media platform to post a message regarding the content. The message may be pre-generated by the content distribution service 120 and, as mentioned, include an embedded link to allow another to download the mobile application 216 and/or playback the shared content.

In some embodiments, the content distribution service 120 may be configured to assume that the user has posted to a social media platform based on the user's interaction with the appropriate element via the GUI of the mobile application 216 (e.g., as shown in FIG. 20D). Alternatively, the content distribution service 120 may wait for an acknowledgement from the social media platform (e.g., received via the API) that the user has shared a post. This confirmation may be stored in a central database of content distribution service 120 along with an identifier associated with the content and the user as verification that the user has successfully shared the content with others.

As indicated in FIG. 11, in response to verifying that the user has shared the content, process 1100 continues with unlocking the content for the user. In this way, the share to unlock feature may encourage users to share content with others (in order to unlock the content) thereby promoting viral adoption of content. In some embodiments, the share to unlock feature unlocks the content to the user for a limited period of time, for example, 24 hours. During this limited unlock period, the user may view/play the content an unlimited number of times. In some embodiments, the user is limited to a particular number of unlocks based on shares. For example, a user may be limited to three shares to unlock the content for three separate 24 hour periods. Conversely, the purchase to unlock feature may permanently unlock the content to the user. This difference in the type of unlocking may encourage users to purchase content they really like which in turn drives revenue for the artists.

Note that the two options to unlock shown in the flow diagram of FIG. 11 are examples provided for illustrative purposes and are not to be construed as limiting. In other embodiments, other options may be presented to users. For example, the system may provide an option to unlock content by entering a code or scanning a graphical code (e.g., a QR code) obtained by the user as part of a promotion. In other embodiments, the system may provide an option to unlock the content by purchasing other related items such as merchandise offered by the content creator 103a. In other embodiments, the system may provide an option to unlock the content by going to a particular physical location. For example, the content distribution service 120 and a third-party venue such as a store or concert hall may jointly offer a promotion such that an option to unlock certain content is provided to the user via the mobile application 216 when the content distribution service 120 detects that the user's computing device is within proximity to the particular physical location. In other embodiments, the system may provide an option to unlock the content by submitting feedback (e.g., in the form of likes) associated with the content and/or the content creator via the content distribution service 120. In other embodiments, the system may provide an option to the user to unlock the content by performing some other type of action such as uploading a picture of themselves wearing attire (e.g., a t-shirt) associated with the content, content creator, and/or the content distribution service 120.

### Administrator Workflow

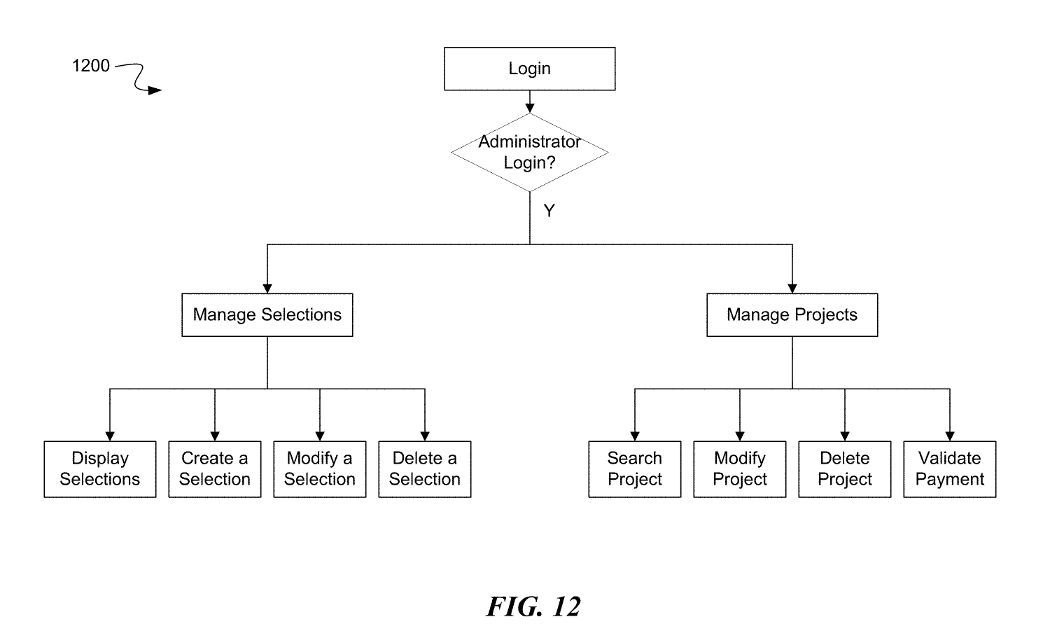

FIG. 12 is a flow diagram of an example user interaction flow 1200 for an administrator user 103c. As previously discussed an administrator user may be associated with a provider of the content distribution service 120 and may utilize administrator privileges, for example, for managing projects, managing user accounts, validating payment, managing other services, and curating content presented to end users, for example, by managing “selections” of content. Selections generally refer to curated sets of content from one or more content creators 103a. For example, a selection may include an audio track playlist and/or a video playlist. End users browsing the mobile application 216 may view the selection and utilize the selections to discover new content.

### Content Consumer Workflows

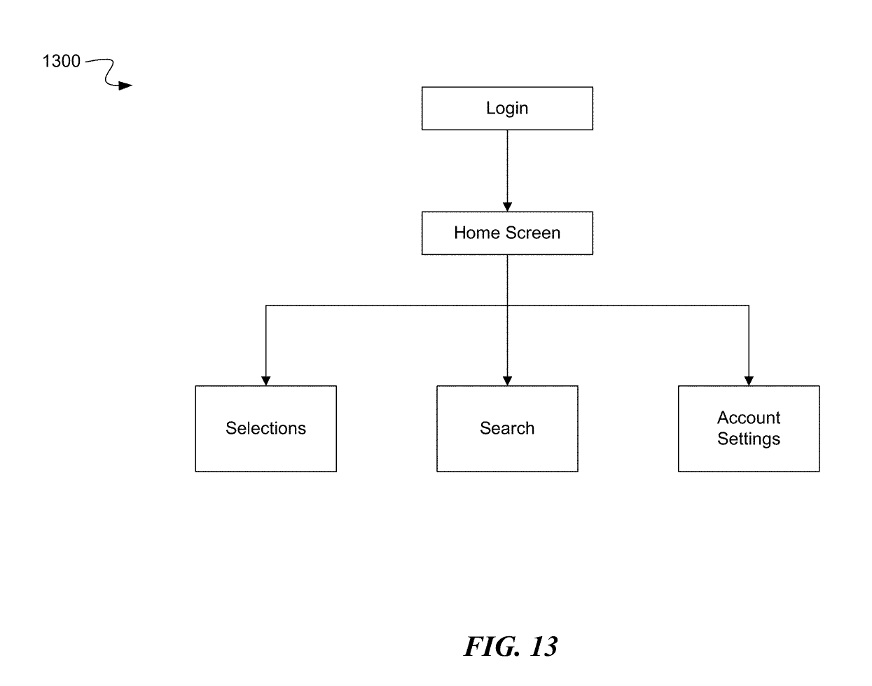

FIGS. 13-16 are a series of flow diagrams describing example interaction flows performed by a content consumer 103b, for example, via the mobile application 216 associated with the content distribution service 120.

FIG. 13 is a flow diagram of an example user interaction flow 1300 as a user navigates through various features of a mobile application 216. As shown in FIG. 13, after logging in, a user is presented with a home screen through which they may access selections of content, a search interface, and edit account settings. As an illustrative example, FIG. 20A shows an example GUI home screen 2000a of mobile application 216 that includes interactive options to view content selections (listed as “hits” in FIG. 20A), view content (e.g., “videos”), search for content, and view favorites. A person having ordinary skill in the relevant technology will recognize that the example home screen of mobile application 216 depicted in FIG. 20A is provided for illustrative purposes and is not to be construed as limiting. Other embodiments may include more or fewer interactive graphical elements and may arrange the interactive graphical elements differently.

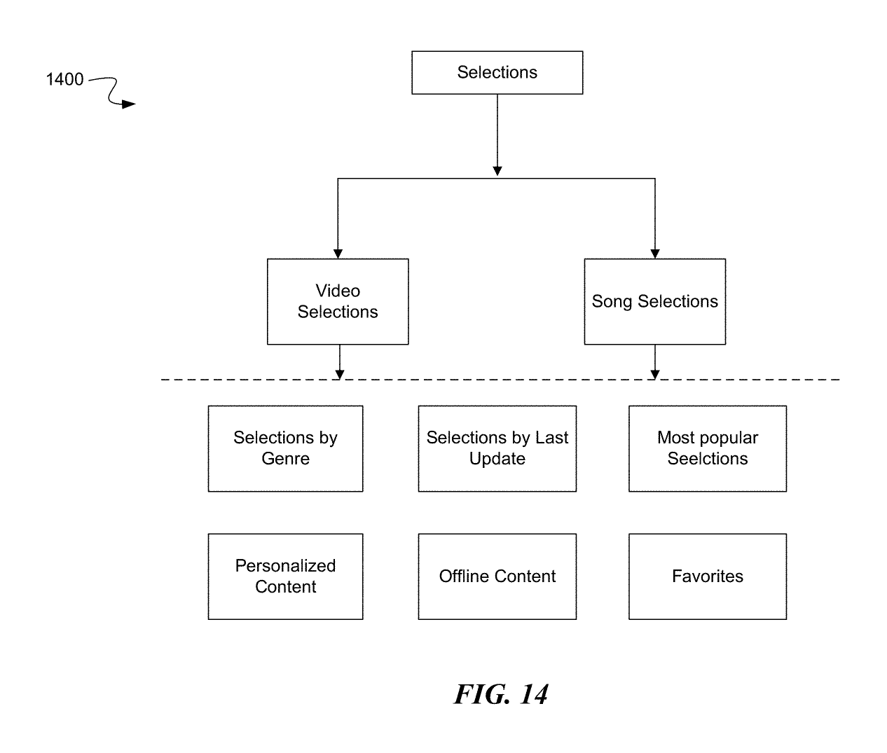

FIG. 14 is a flow diagram of an example user interaction flow 1400 for navigating various curated selections via the mobile application 216. For example, in response to selecting a graphical interactive element (e.g., titled “selections” or “hits”) via the GUI home screen 2000a (shown in FIG. 20A), a user may be presented with options to view video selections (i.e., video playlists) and audio selections (i.e., music playlists). With each option, content selections may include genre related selections, newly updated selections, currently popular selections (e.g., based on plays/views/shares by a plurality of other users), selections personalized to a particular users (e.g., based on user viewing/playback habits, purchase history, shares, favorites, etc.), selections including the user's downloaded offline content, selections including the user's favorite content, user-created selections (i.e., customized playlists), etc.

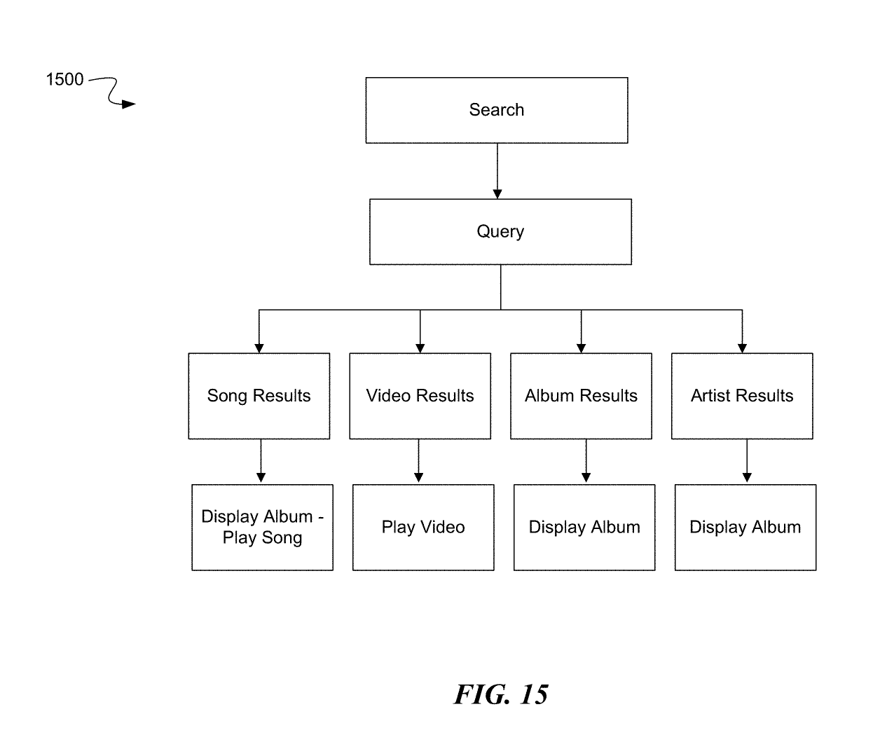

FIG. 15 is a flow diagram of an example user interaction flow 1500 for searching for content via the mobile application 216. For example, in response to selecting a graphical interactive element (e.g., titled “search”) via the GUI home screen 2000a (shown in FIG. 20A), a user may be presented with an option to input a query to search for content. The query may be entered via text or as an audio input, for example, using voice recognition technology. As shown in FIG. 15, the content distribution service 120 may return various types of results such as audio content results (e.g., individual tracks), video results, album results, artist results, etc. From this same interface the user can then select one or more of the returned results to view information about the returned result (e.g., an artist biography) and/or initiate viewing/playback of selected content.

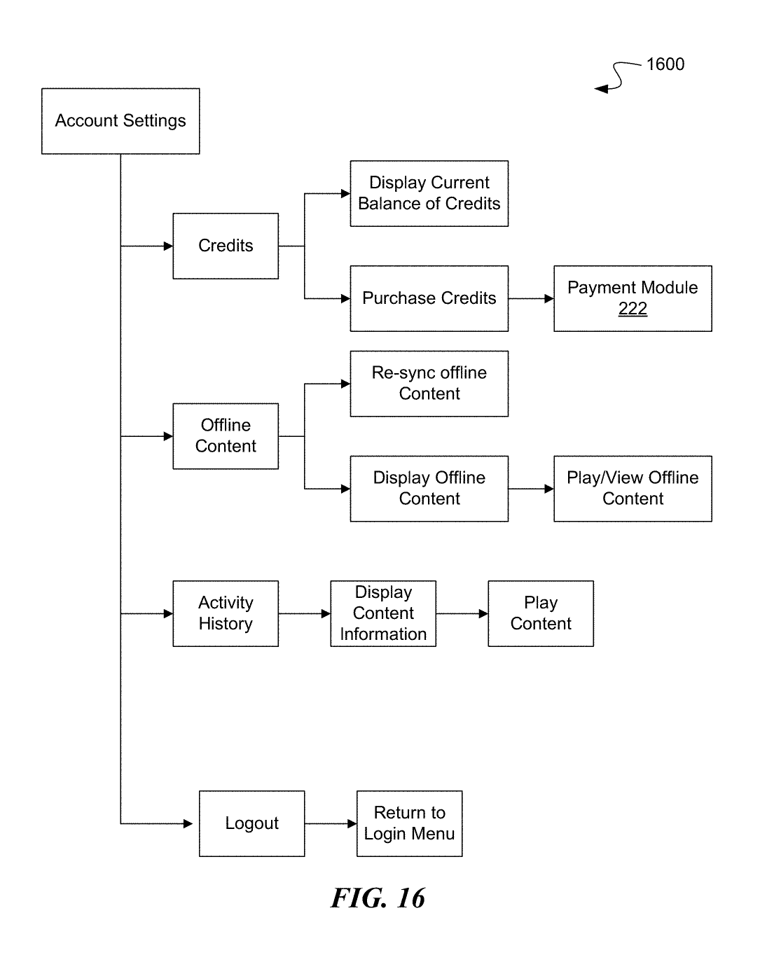

FIG. 16 is a flow diagram of an example user interaction flow 1600 for navigating certain account settings via the mobile application 216. As shown in FIG. 16, in some embodiment, the account setting may include an option to view current credits and/or purchase additional credits. As an illustrative example, FIG. 20F shows an example GUI screen 2000f of mobile application 216 that displays a current balance of credits (e.g., 99 credits) as well as interactive options to purchase various amounts of additional credits. As previously discussed, when setting up an account, a user may be prompted to link the account with an external financial account such as a bank account or credit card. Interaction between external financial services 145 and the content distribution service 120 may be handled by a payment module 222 associated with the content distribution service 120. Accordingly, in such embodiments selection by a user, via GUI screen 2000f, of one of the interactive options to purchase credits may cause the payment module to communicate with an external financial service 145 (e.g., a credit card issuer associated with the user) to effectuate a transfer of funds (e.g., in a currency such as U.S. Dollars) from the user to a financial account associated with the content distribution service 120. In exchange, credits for the amount listed (e.g., 10 credits for 1 U.S. Dollar) are then added to the user's account balance with the content distribution service 120.

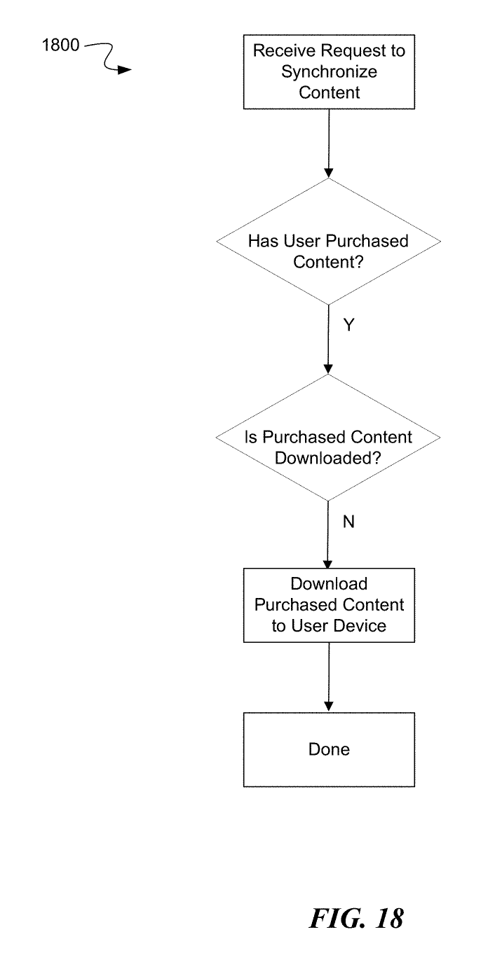

Through the account settings, a user may also be provided an option to re-synchronize offline content stored locally at their client computing device 102b with their listing of unlocked content stored in a central database of the content distribution service 120. A process for synchronizing such information is described further with respect to the flow diagram in FIG. 18.

Through the account setting a user may also view a user activity history. The history may include a history of viewed/played content, a history of credit purchases, a history of content purchases using credits, a history of social media interactions (e.g., likes, shares, etc.), as well as other types of user activity.

### Compression of Uploaded Content

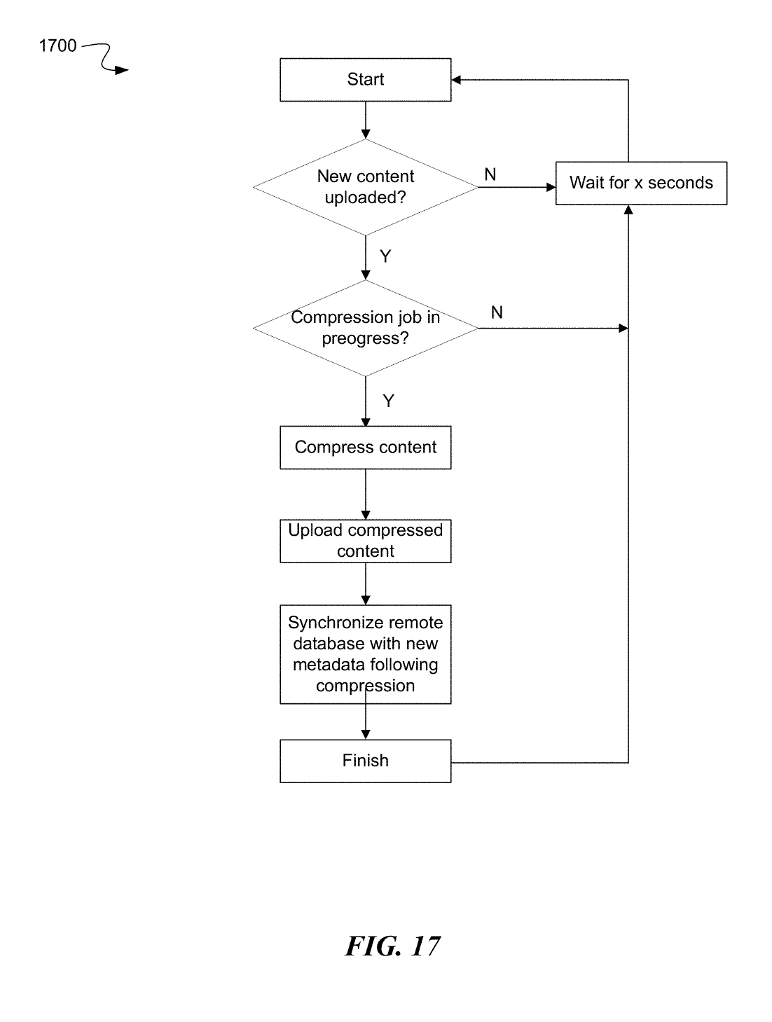

FIG. 17 is a flow diagram of an example process 1700 for compressing content uploaded tot the content distribution service 120. The example process 1700 begins in response to detecting new content uploaded, for example, by a content creator 103a to the content distribution service 120. In some embodiments, the uploaded content may actually be stored at a third-party cloud computing service such as an Amazon™ AWS S3 store. Metadata associated with the uploaded content (e.g., artist name, title, file type, AWS S3 URL, etc.) is stored in a central database associated with the content distribution service 120. Periodically at regular or irregular intervals (e.g., every 60 seconds), a content compression service queries the central database for the metadata to determine if a new content compression job is needed. A person having ordinary skill in the art will recognize that multiple different compression services may be utilized to compress different types of content such as video, audio, images, etc.

If, based on the querying, the compression service determines that a new content compression job is needed, the content is downloaded from the cloud computing service (e.g., using the URL included in the metadata) to the compression service and the compression job is initiated.

When the compression job is completed, the compression service may upload the compressed content to the cloud computing service (e.g., Amazon AWS) for storage and also upload the compressed content to a CDN for delivery through streaming to content consumers 103b.

Once the newly compressed content is uploaded, the content record at the content distribution service 120 (i.e., the stored metadata) is updated, for example, with new URLs associated with the compressed content for storage and for streaming.

### Synchronization Between a Local Computing Device and the Remote Content Distribution Service

FIG. 18 is a flow diagram of an example process 1800 for synchronization between a local computing device and a remote content distribution service. In some embodiments, process 1800 begins with receiving a user request to synchronize or re-synchronize a local information stored, for example, a client computing device 102b with information stored, for example, in a central database of the content distribution service 120. As previously mentioned, such a user request may be based on detection of a user interaction with an interactive graphical element presented via a GUI of the mobile application 216. A user may elect to synchronize or re-synchronize information in response to loss of data at the user's computing device 102b, loss of a previous computing device 102b, a period of disconnection from the internet, etc.

In response to receiving the user request to synchronize, process 1800 continues with accessing information at the content distribution service 120, for example, stored in a central database and comparing the accessed information to information stored locally at the client computing device 102b. As previously discussed, the system may be configured to default to the information stored remotely in a central database.

If, based on the comparison, the sets of information do not match, process 1800 may continue with taking steps to conform with the information at the central database. For example, if a user has unlocked a track, but that unlocked track does not appear in a local copy of the unlocked content list and/or that track has not been downloaded to the client computing device 102b, process 1800 may continue with updating the local copy of the unlocked content list to add a content ID associated with the unlocked track and/or downloading the unlocked track to the client computing device 102b.

### Computer Implementation

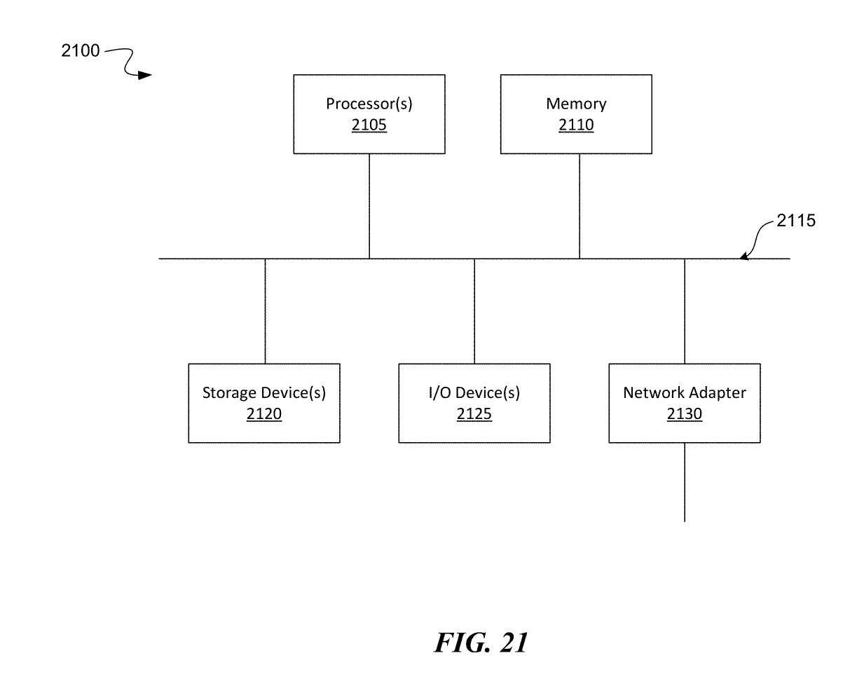

FIG. 21 is a block diagram of an example computer system 2100 as may be used to implement certain features of some of the embodiments. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions, sequential or otherwise, that specify actions to be taken by that machine.

The computing system 2100 may include one or more central processing units (“processors”) 2105, memory 2110, input/output devices 2125, e.g. keyboard and pointing devices, touch devices, display devices, storage devices 2120, e.g. disk drives, and network adapters 2130, e.g. network interfaces, that are connected to an interconnect 2115. The interconnect 2115 is illustrated as an abstraction that represents any one or more separate physical buses, point to point connections, or both connected by appropriate bridges, adapters, or controllers. The interconnect 2115, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called Firewire.

The memory 2110 and storage devices 2120 are computer-readable storage media that may store instructions that implement at least portions of the various embodiments. In addition, the data structures and message structures may be stored or transmitted via a data transmission medium, e.g. a signal on a communications link. Various communications links may be used, e.g. the Internet, a local area network, a wide area network, or a point-to-point dial-up connection. Thus, computer readable media can include computer-readable storage media, e.g. non-transitory media, and computer readable transmission media.

The instructions stored in memory 2110 can be implemented as software and/or firmware to program the processor 2105 to carry out actions described above. In some embodiments, such software or firmware may be initially provided to the processing system 2100 by downloading it from a remote system through the computing system 300, e.g. via network adapter 2130.

The various embodiments introduced herein can be implemented by, for example, programmable circuitry, e.g. one or more microprocessors, programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

What is claimed is:

1. A method performed by a server computer system implementing a content distribution service, the method comprising:
receiving, by the server computer system, via a computer network, from a first client computing device, an input by a first user defining a distribution model for a content item created by the first user and hosted by the content distribution service, the input by the first user defining the distribution model by setting parameters for conditional access to the content item by other users of the content distribution service;
generating, by the server computer system, distribution model metadata based on the parameters set by the received input by the first user;
storing, by the server computer system, the distribution model metadata in a database of the content distribution service and associating the stored distribution model metadata with the content item;
receiving, by the server computer system, via the computer network, from a second client computing device, a request by a second user to access the content item;
determining, by the server computer system, in response to the request, that:
the second user has not unlocked the content item by accessing a listing of content unlocked by the second user and determining that a content identifier associated with the content item is not included in the listing, the listing of content unlocked by the second user stored in the database; and
the request by the second user to access the content item does not satisfy the parameters for conditional access to the content item by comparing the distribution model metadata to the request; and
in response to the determining:
restricting access to the content item by the second user; and
presenting to the second user, via the second client computing device, a prompt including a plurality of options to unlock the content item based on the distribution model metadata associated with the content item.

2. The method of claim 1, wherein the plurality of options to unlock the content item include:
an option to purchase the content item; and
and option to share a post regarding the content item via a social media platform.

3. The method of claim 1, further comprising:
receiving, by the server computer system, via the computer network, from the second client computing device, in response to the prompt, a request by the second user to purchase the content item;
verifying, by the server computer system, successful purchase of the content item by the second user;
recording by the server computer system, the content identifier associated with the content item to the listing of content unlocked by the second user; and
enabling, by the server computer system, the second user unlimited access to the content item.

4. The method of claim 3, further comprising:
causing, by the server computer system, the content item to download automatically to the second client computing device;
wherein the second user can access the downloaded content item at the second client computing device without connecting, via the computer network, to the content distribution service.

5. The method of claim 1, further comprising:
receiving, by the server computer system, via the computer network, from the second client computing device, in response to the prompt, a request by the second user to share a post regarding the content item via a social media platform;
enabling, by the server computer system, the second user to submit the post regarding the content item to the social media platform using an application programming interface (API) associated with the social media platform;
receiving, by the server computer system, from the social media platform, via the API, an acknowledgment that the second user successfully submitted the post;
recording by the server computer system, the content identifier associated with the content item to the listing of content unlocked by the second user; and
enabling, by the server computer system, the second user unlimited access to the content for a limited period of time.

6. The method of claim 1, further comprising:
enabling, by the server computer system, the second user to access the content item, via the second client computing device, immediately in response to the request from the second user; and
waiting for a period of time before restricting access to the second user if the content item is not unlocked and the request by the second user to access the content item does not satisfy the parameters for conditional access to the content item.

7. The method of claim 1, wherein the content item includes any of an audio file, a video file, or an image file.

8. The method of claim 1, wherein:
the input by the first user is received from the first client computing device via a web-based dashboard; and
the request by the second user to access the content item is received from the second client computing device via a mobile application installed at the second client computing device.

9. The method of claim 1, wherein the parameters for conditional access to the content item include in the distribution model define any of:
a limitation on a number of free plays or views of the content item;
a limitation on a number of free plays or views of the content item over a particular period of time; or
a limitation on a physical location of the second user when accessing the content item.

10. A server computer system implementing a content distribution service, the server computer system comprising:
one or more processors; and
a memory communicatively coupled to the one or more processors, the memory including instructions stored thereon, which when executed by the one or more processors cause the server computer system to:
receive, via a computer network, from a first client computing device, an input by a first user defining a distribution model for a content item created by the first user and hosted by the content distribution service, the input by the first user defining the distribution model by setting parameters for conditional access to the content item by other users of the content distribution service;
generate distribution model metadata based on the parameters set by the received input by the first user;
store the distribution model metadata in a database of the content distribution service and associate the stored distribution model metadata with the content item;
receive, via the computer network, from a second client computing device, a request by a second user to access the content item;
determine, in response to the request, that:
the second user has not unlocked the content item by accessing a listing of content unlocked by the second user and determining that a content identifier associated with the content item is not included in the listing, the listing of content unlocked by the second user stored in the database; and
the request by the second user to access the content item does not satisfy the parameters for conditional access to the content item by comparing the distribution model metadata to the request; and
in response to the determining:
restrict access to the content item by the second user; and
present to the second user, via the second client computing device, a prompt including a plurality of options to unlock the content item based on the distribution model metadata associated with the content item.

11. The server computer system of claim 10, wherein the plurality of options to unlock the content item include:
an option to purchase the content item; and
and option to share a post regarding the content item via a social media platform.

12. The server computer system of claim 10, wherein the memory includes further instructions stored thereon, which when executed by the one or more processors, cause the server computer system to further:
receive, in response to the prompt, a request by the second user to purchase the content item;
verify successful purchase of the content item by the second user;
record the content identifier associated with the content item to the listing of content unlocked by the second user; and
enable the second user unlimited access to the content item.

13. The server computer system of claim 12, wherein the memory includes further instructions stored thereon, which when executed by the one or more processors, cause the server computer system to further:
cause the content item to download automatically to the second client computing device associated with the second user;
wherein the second user can access the downloaded content item at the second client computing device without connecting, via the computer network, to the content distribution service.

14. The server computer system of claim 10, wherein the memory includes further instructions stored thereon, which when executed by the one or more processors, cause the server computer system to further:
receive, via the computer network, from the second client computing device, in response to the prompt, a request by the second user to share a post regarding the content item via a social media platform;
enable the second user to submit the post regarding the content item to the social media platform using an application programming interface (API) associated with the social media platform;
receive from the social media platform, via the API, an acknowledgment that the second user successfully submitted the post;
record by the server computer system, the content identifier associated with the content item to the listing of content unlocked by the second user; and
enable the second user unlimited access to the content for a limited period of time.

15. The server computer system of claim 10, wherein the memory includes further instructions stored thereon, which when executed by the one or more processors, cause the server computer system to further:
enable the second user to access the content item, via the second client computing device, immediately in response to the request from the second user; and
wait for a period of time before restricting access to the second user if the content item is not unlocked and the request by the second user to access the content item does not satisfy the parameters for conditional access to the content item.

16. A non-transitory computer-readable medium including instructions for causing a server computer system implementing a content distribution service to:
receive, via a computer network, from a first client computing device, an input by a first user defining a distribution model for a content item created by the first user and hosted by the content distribution service, the input by the first user defining the distribution model by setting parameters for conditional access to the content item by other users of the content distribution service;
generate distribution model metadata based on the parameters set by the received input by the first user;
store the distribution model metadata in a database of the content distribution service and associate the stored distribution model metadata with the content item;
receive, via the computer network, from a second client computing device, a request by a second user to access the content item;
determine, in response to the request, that:
the second user has not unlocked the content item by accessing a listing of content unlocked by the second user and determining that a content identifier associated with the content item is not included in the listing, the listing of content unlocked by the second user stored in the database; and
the request by the second user to access the content item does not satisfy the parameters for conditional access to the content item by comparing the distribution model metadata to the request; and
in response to the determining:
restrict access to the content item by the second user; and
present to the second user, via the second client computing device, a prompt including a plurality of options to unlock the content item based on the distribution model metadata associated with the content item.

17. The non-transitory computer-readable medium of claim 16, wherein the plurality of options to unlock the content item include:
an option to purchase the content item; and
and option to share a post regarding the content item via a social media platform.

18. The non-transitory computer-readable medium of 16, including further instructions for causing the server computer system to further:
receive, in response to the prompt, a request by the second user to purchase the content item;
verify successful purchase of the content item by the second user;
record the content identifier associated with the content item to the listing of content unlocked by the second user; and
enable the second user unlimited access to the content item.

19. The non-transitory computer-readable medium of 18, including further instructions for causing the server computer system to further:
cause the content item to download automatically to the second client computing device associated with the second user;
wherein the second user can access the downloaded content item at the second client computing device without connecting, via the computer network, to the content distribution service.

20. The non-transitory computer-readable medium of 16, including further instructions for causing the server computer system to further:
receive, via the computer network, from the second client computing device, in response to the prompt, a request by the second user to share a post regarding the content item via a social media platform;
enable the second user to submit the post regarding the content item to the social media platform using an application programming interface (API) associated with the social media platform;
receive from the social media platform, via the API, an acknowledgment that the second user successfully submitted the post;
record by the server computer system, the content identifier associated with the content item to the listing of content unlocked by the second user; and
enable the second user unlimited access to the content for a limited period of time.
